(19) United States
(12) Patent Application Publication
(10) Pub. No.: US 2026/0105640 A1
(43) Pub. Date: Apr. 16, 2026

(54) METHOD FOR ENCODING/DECODING FEATURE MAP AND RECORDING MEDIUM STORING INSTRUCTIONS THEREFOR

(71) Applicants: Electronics and Telecommunications Research Institute, Daejeon (KR); UNIVERSITY-INDUSTRY COOPERATION GROUP OF KYUNG HEE UNIVERSITY, Yongin-si (KR)

(72) Inventors: JooYoung LEE, Daejeon (KR); Se Yoon JEONG, Daejeon (KR); Youn Hee KIM, Daejeon (KR); Jung Won KANG, Daejeon (KR); Hui Yong KIM, Yongin-si (KR); Hye Won JEONG, Yongin-si (KR); Dal Hong LIM, Yongin-si (KR); Seung Hwan JANG, Yongin-si (KR); Yeong Woong KIM, Yongin-si (KR)

(73) Assignees: Electronics and Telecommunications Research Institute, Daejeon (KR); UNIVERSITY-INDUSTRY COOPERATION GROUP OF KYUNG HEE UNIVERSITY, Yongin-si (KR)

(21) Appl. No.: 19/180,387

(22) Filed: Apr. 16, 2025

(30) Foreign Application Priority Data
Apr. 17, 2024 (KR) 10-2024-0051697
Apr. 30, 2024 (KR) 10-2024-0058057

(51) Int. Cl. G06T 9/00

(52) U.S. Cl. CPC G06T 9/001

(57) ABSTRACT

A method of decoding a feature map according to the present disclosure comprises reconstructing an intermediate latent representation of a current layer from a reconstructed latent representation by obtaining decoding an image; generating an adaptive latent representation or a fused latent representation based on the intermediate latent representation of the current layer, and reconstructing a feature map of the current layer by performing channel separation to the adaptive latent representation or the fused latent representation.

### TECHNICAL FIELD

The present disclosure relates to a method and a device for encoding/decoding a feature map.

### BACKGROUND ART

A traditional image compression technology has been developed to ensure that when a compressed image is reconstructed, a reconstructed image is as similar as possible to the original based on human vision. In other words, an image compression technology has been developed towards minimizing a bit rate and maximizing the image quality of a reconstructed image at the same time.

As an example, an encoder receives an image as input to generate a bitstream through a transform and entropy encoding process for an input image, and a decoder receives a bitstream as input to reconstruct it to an image similar to the original.

To measure similarity between an original image and a reconstructed image, an objective image quality evaluation scale or a subjective image quality evaluation scale may be used. Here, Mean Squared Error (MSE), etc. which measures a difference in pixel values between an original image and a reconstructed image is mainly used as an objective image quality evaluation scale. Meanwhile, a subjective image quality evaluation scale means that a person evaluates a difference between an original image and a reconstructed image.

Meanwhile, as machine vision working performance has been improved, a growing number of machines, instead of persons, have watched and consumed an image. As an example, in fields such as a smart city, an autonomous car, an airport surveillance camera, etc., an increasing number of images are used based on machines, not persons.

Accordingly, recently, other than traditional image compression focusing on persons, there is a growing interest in an image compression technology centered on machine vision.

### DISCLOSURE

### Technical Problem

The present disclosure provides a method for dividing a feature map into multiple channel groups through channel adjustment, and obtaining a latent representation of the feature map by combining the intermediate latent representations of each of the channel groups.

The present disclosure provides a method for encoding/decoding a multilayer feature map through a single neural network model by adjusting the number of channels of an input multilayer feature map to be the same.

The technical objects to be achieved by the present disclosure are not limited to the above-described technical objects, and other technical objects which are not described herein will be clearly understood by those skilled in the pertinent art from the following description.

### Technical Solution

A method of decoding a feature map according to the present disclosure comprises reconstructing an intermediate latent representation of a current layer from a reconstructed latent representation by obtaining decoding an image; generating an adaptive latent representation or a fused latent representation based on the intermediate latent representation of the current layer; and reconstructing a feature map of the current layer by performing channel separation to the adaptive latent representation or the fused latent representation.

In a method of decoding a feature map according to the present disclosure, the channel separation represents separating the adaptive latent representation or the fused latent representation into a plurality of channel groups according to a number of channels of the feature map.

In a method of decoding a feature map according to the present disclosure, the adaptive latent representation is obtained by adapting the intermediate latent representation of the current layer to a feature map of a reconstruction target layer, and the fused latent representation is obtained by fusing the intermediate latent representation of the current layer and an intermediate latent representation of a previous layer.

In a method of decoding a feature map according to the present disclosure, in response to the current layer being a first layer, the intermediate latent representation of the previous layer is replaced by an intermediate latent representation that values therein are padded by a pre-defined value.

In a method of decoding a feature map according to the present disclosure, the pre-defined value is 0.

In a method of decoding a feature map according to the present disclosure, in response to the current layer being a first layer, the intermediate latent representation of the previous layer is not input.

In a method of decoding a feature map according to the present disclosure, the channel separation is performed by inputting the adaptive latent representation or the fused latent representation to a 1×1 convolution kernel.

In a method of decoding a feature map according to the present disclosure, the channel separation is performed by unpadding the adaptive latent representation or the fused latent representation.

In a method of decoding a feature map according to the present disclosure, the channel separation is performed by unpadding at least one of a plurality of channels obtained by inputting the adaptive latent representation or the fused latent representation to a 1×1 convolution kernel.

A method of encoding a feature map according to the present disclosure comprises adjusting a number of channels of a feature map of a current layer; separating the feature map with the adjusted number of channels into a plurality of channel groups; transforming each of the plurality of channel groups into an intermediate latent representation; and obtaining a feature map latent representation of the current layer by merging intermediate latent representations.

In a method of encoding a feature map according to the present disclosure, a number of the channel groups does not exceed a pre-defined value.

In a method of encoding a feature map according to the present disclosure, the feature map is separated to the plurality of channel group so as that a number of channels of each of the channel group to be the same as a number of channels input for transforming into an intermediate latent representation.

In a method of encoding a feature map according to the present disclosure, a number of channels of the feature map of the current layer is adjusted to a reference number.

In a method of encoding a feature map according to the present disclosure, in response to the number of channels of the feature map of the current layer is the same as the reference number, adjusting the number of channels for the feature map of the current layer is skipped.

In a method of encoding a feature map according to the present disclosure, the reference number is set to be the same as a number of channels of a layer that has a largest number of channels among a plurality of layers.

In a method of encoding a feature map according to the present disclosure, the intermediate latent representation is obtained based on a corresponding channel group and a feature map latent representation of a previous layer.

In a method of encoding a feature map according to the present disclosure, in response to the current layer being a first layer, the feature map latent representation of the previous layer is replaced by a feature map latent representation that values therein are padded by a pre-defined value.

In a method of encoding a feature map according to the present disclosure, the pre-defined value is 0.

In a method of encoding a feature map according to the present disclosure, the feature map latent representation of the current layer is obtained by connecting the intermediate latent representations in a channel direction and then inputting connected intermediate latent representations into a 1×1 convolution kernel.

According to the present disclosure, a computer readable recording medium recording the feature map encoding/decoding method may be provided.

The technical objects to be achieved by the present disclosure are not limited to the above-described technical objects, and other technical objects which are not described herein will be clearly understood by those skilled in the pertinent art from the following description.

### Technical Field

According to the present disclosure, a method of dividing a feature map into multiple channel groups through channel adjustment, and obtaining a latent representation of the feature map by combining the intermediate latent representations of each of the channel groups can be provided.

According to the present disclosure, a method of encoding/decoding a multilayer feature map through a single neural network model by adjusting the number of channels of the multilayer feature map to be the same may be provided.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 is an example of the results of a machine task that perform object detection and classification using Fast R-CNN, one of artificial neural networks.

FIG. 2 is a diagram illustrating a multi-layer feature map.

FIG. 3 shows an artificial neural network model of the Mask-RCNN structure.

FIG. 4 illustrates a multi-layer feature map Pₖ extracted through FPN of Mask R-CNN.

FIG. 5 shows an example of extracting a multi-layer feature map based on YOLO v3.

FIG. 6 illustrates an example in which a feature map extraction unit and a task performing unit exist in different devices.

FIG. 7 is a schematic diagram of a neural network-based image encoding/decoding method according to the present disclosure.

FIG. 8 is a diagram showing a neural network-based multi-layer feature map encoding/decoding process.

FIG. 9 is a diagram illustrating a multi-layer feature map encoding/decoding process based on a neural network including a gain unit and an inverse gain unit.

FIG. 10 shows an example of an image or a feature map image being compressed by a convolution-based neural network.

FIG. 11 shows an example of compressing an image or a feature map image using a multilayer perceptron-based neural network.

FIG. 12 shows an example in which a neural network-based compression model is defined according to the number of channels of an input feature map.

FIG. 13 is a block diagram of a device including a neural network structure for feature map encoding/reconstructing according to one embodiment of the present disclosure.

FIG. 14 illustrates a neural network-based compression model including a channel number adjustment unit according to one embodiment of the present disclosure.

FIGS. 15 to 17 illustrate a neural network-based compression model to which at least one of an intermediate latent representation transform unit or a channel separation unit is added according to one embodiment of the present disclosure.

FIG. 18 illustrates a neural network-based compression model including a latent representation channel merging unit according to one embodiment of the present disclosure.

FIG. 19 illustrates an example for explaining the overall operations of a channel-separable latent representation transform unit.

FIG. 20 shows an example of using multiple channel-separable latent representation transform units.

FIGS. 21 and 22 illustrate detailed operations of a channel-separable feature map reconstruction unit.

FIGS. 23 and 24 illustrate examples of using channel-separable latent representation reconstruction units as many as the number of layers.

FIGS. 25 and 26 illustrate examples of generating feature map latent representations in a channel-separable latent representation transformation unit.

FIGS. 27 and 28 illustrate examples of reconstructing feature maps in parallel in a channel-separable feature map reconstruction unit.

FIGS. 29 and 30 illustrate examples of reconstructing feature maps sequentially in a channel-separable feature map reconstruction unit.

FIG. 31 is a flow chart of a method of encoding a feature map according to an embodiment of the present disclosure.

FIG. 32 is a flow chart of a method of decoding a feature map according to an embodiment of the present disclosure.

FIG. 33 shows an example of a case where a single-layer feature map is input.

FIG. 34 shows an example of a case where a multi-layer feature map is input.

FIG. 35 shows an example in which the number of channels is adjusted based on a convolution kernel.

FIG. 36 shows an example in which the number of channels is adjusted through channel padding.

FIG. 37 shows an example of adjusting the number of channels of intermediate feature maps output from various machine vision models to be the same.

FIG. 38 illustrates an example in which each of a plurality of channel groups, generated through channel separation, is input to the intermediate latent representation transform unit.

FIG. 39 illustrates an example in which channel separation is performed based on a convolution kernel.

FIG. 40 illustrates an example in which the separation method is determined differently depending on the channel order.

FIG. 41 illustrates an example of the operation of the latent representation transform unit.

FIG. 42 illustrates an example in which the channel group and the feature map latent representation of the previous layer are connected in the channel direction in the connection unit.

FIG. 43 illustrates an example of a configuration diagram of an intermediate latent representation transform block.

FIG. 44 illustrates a case where at least one of the intermediate latent representation transform units is not used.

FIG. 45 illustrates a detailed operation of the latent representation channel merging unit.

FIG. 46 illustrates a configuration of the feature map transform unit.

FIG. 47 illustrates a configuration of the latent representation fusion unit.

FIG. 48 illustrates a configuration of the latent representation adaptation unit.

FIG. 49 shows an example in which channel separation is performed based on convolution kernels.

### DETAILED DESCRIPTION OF DISCLOSURE

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from another element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

Machine tasks based on image processing using artificial neural networks (ANNs) are getting widely used. For example, machine vision tasks such as object classification, object recognition, object detection, object segmentation, or object tracking from input images, or image processing tasks such as improving resolution of input images (super-resolution) or frame interpolation for input images are being increasingly utilized.

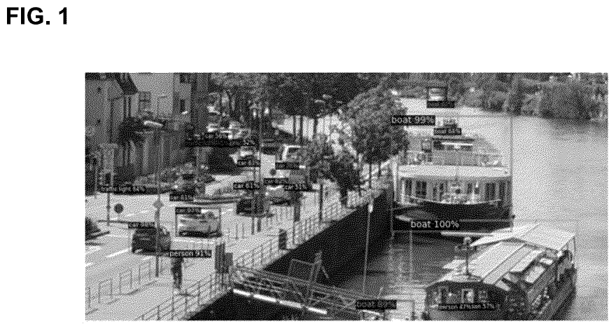

FIG. 1 is an example of the results of a machine task that perform object detection and classification using Fast R-CNN, one of artificial neural networks.

For the machine task described above, necessary of image compression technology for machine vision, not human vision, is hugely increased.

Image compression technology for machine vision minimizes the amount of compression bits, but unlike image compression technology for human vision, it has goals to maximize the performance of machine vision tasks through a restored feature map, not the image quality of restored images.

Meanwhile, an artificial neural network model that performs machine tasks may include a feature map extraction unit that extracts features from input data or input image, and a task performing unit that performs actual a machine task based on the extracted features.

When data input to an artificial neural network model is an image, the features extracted from the feature map extraction unit may be called a feature map. Accordingly, in this disclosure, the features extracted from the feature map extraction unit are called a ‘feature map.’ However, even when the extracted features are not in the form of a map, the embodiments described in this disclosure also may be applied.

The embodiments described in this disclosure may be applied to a multi-layer feature map.

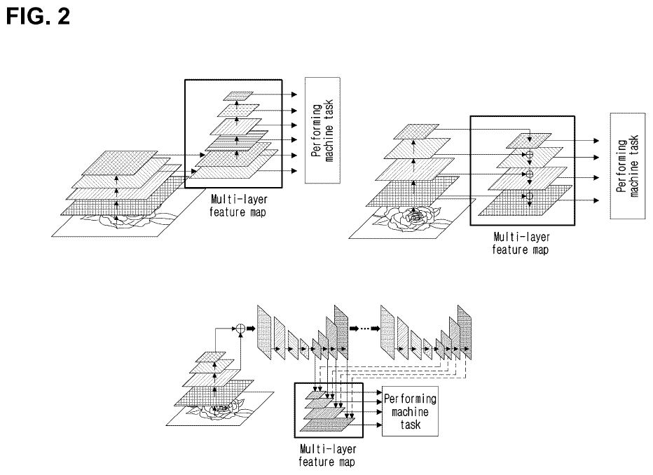

FIG. 2 is a diagram illustrating a multi-layer feature map.

The multi-layer feature map has a structure in which feature maps with different resolutions form multiple layers. A feature map in a higher layer has a lower resolution, and a feature map in a lower layer has a higher resolution. Accordingly, the multi-layer feature map may also be called a pyramid-structured feature map. Meanwhile, the resolutions of feature maps within the same layer may be mutually same.

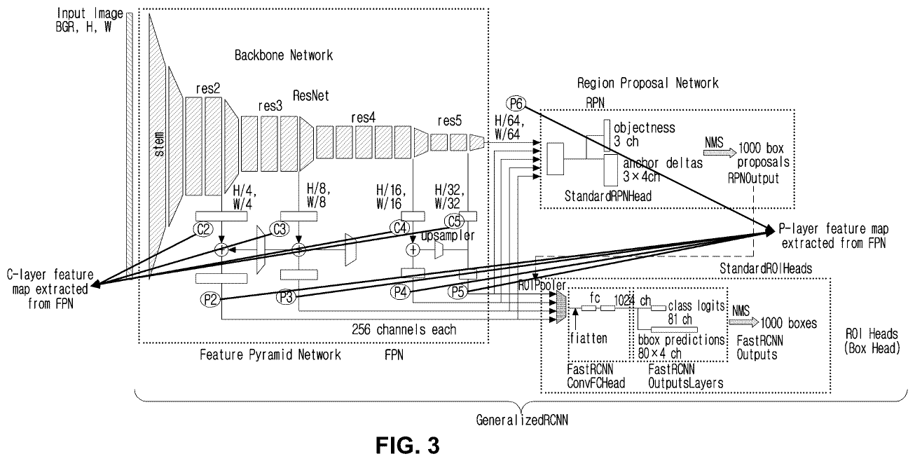

FIG. 3 shows an artificial neural network model of the Mask-RCNN structure.

The artificial neural network model of the Mask-RCNN structure illustrated in FIG. 3 may be mainly utilized for object region segmentation machine task.

In the example illustrated in FIG. 3, a feature pyramid network (FPN) corresponds to a multi-layer feature map extraction unit, and a region proposal network (RPN) and a region of interest heads (ROI Heads) correspond to a machine task performing unit.

In the example illustrated in FIG. 3, the feature pyramid network (FPN) is exemplified as extracting a C-layer feature map and a P-layer feature map. Here, each of the C-layer feature map and the P-layer feature map may be a multi-layer feature map.

The embodiments described below will be described with a focus on the P-layer feature map, but the embodiments described in the present disclosure may be equally applied to a feature map of a different type than the P-layer feature map. Meanwhile, the embodiments described in the present disclosure may be equally applied to not only multi-layer feature maps but also single-layer feature maps.

The feature map may be represented as a two-dimensional array. Accordingly, the size of the feature map can be defined as (width×height).

Meanwhile, a feature map belonging to an arbitrary layer can be composed of one or more channels. Accordingly, the feature map of each layer can be represented as a three-dimensional array having a size of (width×height×number of channels).

That is, when a feature map belonging to layer k is called Fₖ, the feature map Fₖ may be represented as a three-dimensional array Fₖ[x][y][c] composed of extracted feature values. Here, x and y represent the horizontal and vertical positions of a feature value, respectively, and c represents the channel index.

For example, a multi-layer feature map Cₖ or a multi-layer feature map Pₖ extracted from FPN may be a multi-layer feature map Fₖ of the present invention.

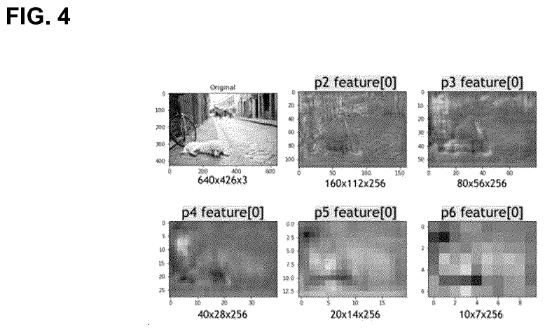

FIG. 4 illustrates a multi-layer feature map Pₖ extracted through FPN of Mask R-CNN.

In FIG. 4, only the feature map in the first channel of the feature map belonging to each layer is illustrated.

In the multi-layer feature map Pₖ extracted from FPN, the resolutions of the feature maps belonging to different layers may be different from each other. For example, as in the example illustrated in FIG. 4, as the layer becomes deeper, the width and height of the feature map may become smaller.

On the other hand, even if the feature maps belong to different layers, the number of channels may be the same. For example, as in the example illustrated in FIG. 4, the feature map of each layer may consist of 256 channels.

The FPN, i.e., the feature map extraction unit, may extract feature maps of five layers, i.e., P₂ to P₆.

Meanwhile, when encoding the extracted feature maps, all of the extracted feature maps of the five layers may be encoded.

Alternatively, encoding/decoding of the layer with the smallest resolution may be omitted/skipped, and the layer whose encoding/decoding has been omitted/skipped may be restored using the neighboring layer.

For example, in the example shown in FIG. 4, only the feature maps of four layers, for example, P₂ to P₅, may be encoded, and the layer whose encoding has been omitted/skipped may be derived from the feature map of the layer that is explicitly encoded/decoded. For example, when encoding/decoding of the feature map P₆ is omitted/skipped, the feature map P₆ may be restored based on the decoded feature map P₅.

In a model for performing a machine task such as YOLO v3, a multi-layer feature map may be extracted in a similar way to the Player feature map of FPN, and these can be used for performing a machine task.

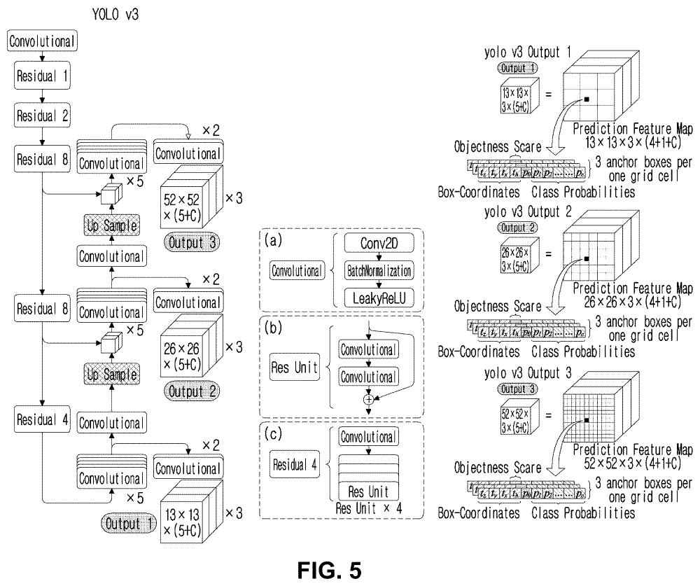

FIG. 5 shows an example of extracting a multi-layer feature map based on YOLO v3.

In FIG. 5, it is exemplified that a multi-layer feature map consisting of three layers (i.e., (Output1, Output2, Output3)) is extracted and machine task is performed based on the extracted multi-layer feature map.

Specifically, in FIG. 5, it is exemplified that darknet 53, which has a pyramid structure similar to FPN, within YOLO v3, utilized as a multi-layer feature map extraction unit.

As explained in FIG. 4, when encoding the extracted feature map, all three layers may be encoded/decoded.

Alternatively, encoding/decoding may be omitted/skipped for the feature map of the layer with the smallest resolution among the extracted feature maps. In this case, the feature map of the layer whose encoding/decoding is omitted/skipped may be restored based on the feature map of another layer that is explicitly encoded/decoded.

Meanwhile, as machine task is used not only on a huge server but also on a device with relatively low computing power such as a mobile device, there may occur a case where the feature map extraction unit and the task performing unit do not exist within the same device.

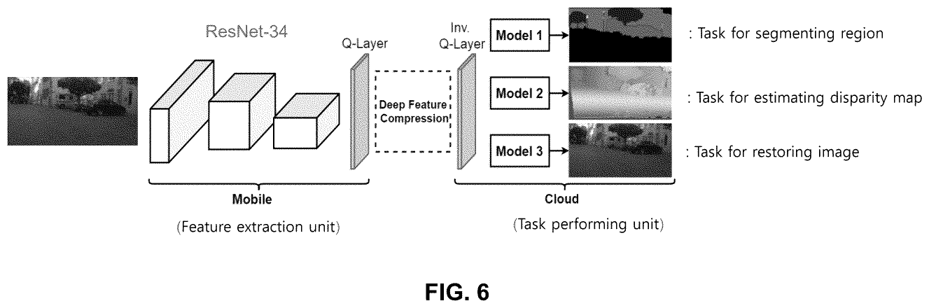

FIG. 6 illustrates an example in which a feature map extraction unit and a task performing unit exist in different devices.

Specifically, in FIG. 6, the feature map extraction unit exists in a mobile device, while the task performing unit for performing a machine task such as object segmentation, disparity map estimation, or image restoration exists in a cloud server.

In this case, a feature map extracted from a mobile device may be transmitted to a server, and a result of the machine task may be fed back to the mobile device from the server.

As in the example illustrated in FIG. 6, if the feature map extraction unit and the task performing unit are separated, the extracted feature map should be transmitted to the task performing unit. Accordingly, a feature map encoding/decoding method may be required to minimize the amount of data of the feature map to be transmitted and stored, while minimizing the degradation of the task performance.

Even if the feature map extraction unit and the task performing unit present in one device, there may be cases where the extracted feature map is stored and later utilized by the task performing unit. In this case as well, a feature map encoding/decoding method may be required to minimize the amount of data of the feature map to be stored.

Accordingly, the present disclosure proposes a method for encoding/decoding a feature map, specifically, a feature map, extracted by the feature map extraction unit.

In the present disclosure, ‘image’ may refer to various types of images, such as a natural image acquired through a camera, a computer graphic, a holographic image, a feature map image extracted through a neural network, or a ultrasound image.

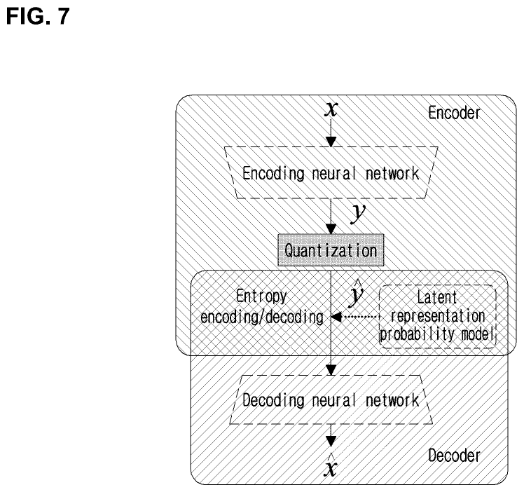

FIG. 7 is a schematic diagram of a neural network-based image encoding/decoding method according to the present disclosure.

The neural network-based image encoding/decoding method according to the present disclosure may be implemented through an encoding neural network, a decoding neural network, quantization, a latent representation probability model, entropy encoding, and entropy decoding, etc.

First, in the encoder, an image to be encoded (i.e., an input image) x may be converted into a latent representation y through an encoding neural network.

Here, the latent representation may represent at least one of a latent vector, a latent representation, or a latent feature map.

In the encoder, each component yᵢ of the latent representation y is quantized.

The quantized latent representation ŷ may be converted into a bitstream through entropy encoding based on a learnable latent representation probability model p_{ŷ}(ŷ) and transmitted to a decoder.

The decoder receives the bitstream and restores the quantized latent representation ŷ through entropy decoding based on the same latent representation probability model in the encoder.

In addition, the decoding neural network may output a restored image \hat{x} in response to the input of the quantized latent representation ŷ.

Meanwhile, in the example illustrated in FIG. 7, the block expressed by the dotted line indicates a learnable parameter or a learnable neural network.

The neural network parameters of the learnable blocks illustrated in FIG. 7 may be learned through a loss function and a backpropagation algorithm.

Meanwhile, the multi-layer feature map is composed of several feature maps with different spatial resolutions. Accordingly, a different method may be required for encoding/decoding the multi-layer feature map than when encoding/decoding a natural image.

Therefore, in the present disclosure, a neural network-based image encoding/decoding method is proposed for the input image of a multi-layer feature map {Fₖ} (k is 1 to L, L is the number of layers). Meanwhile, a smaller value of the variable k may mean a feature map of a layer with a larger spatial resolution.

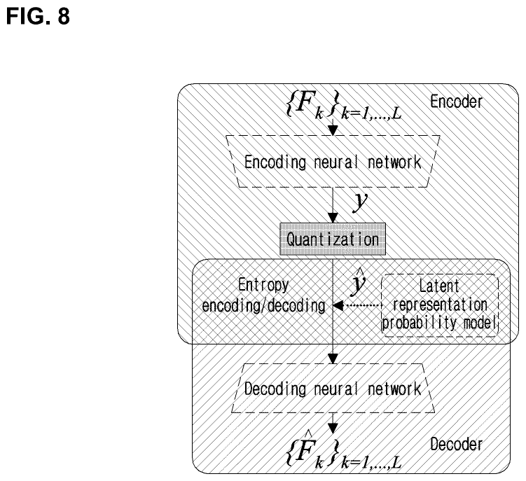

FIG. 8 is a diagram showing a neural network-based multi-layer feature map encoding/decoding process.

In the encoder, the multi-layer feature map {Fₖ} to be encoded may be converted into a latent representation y through an encoding neural network.

In addition, the encoder may quantize each component yᵢ of the latent representation y.

The quantized latent representation ŷ may be converted into a bitstream through entropy encoding based on a learnable latent representation probability model p_{ŷ}(ŷ) and transmitted to the decoder.

In the decoder, once the bitstream is received, the quantized latent representation may be restored through entropy decoding based on the same latent representation probability model in the encoder.

In addition, the decoding neural network generates a restored multi-layer feature map {\hat{F}ₖ} in response to the input of the quantized latent representation ŷ.

Meanwhile, in the example illustrated in FIG. 8, the blocks represented by dotted lines represent learnable parameters or learnable neural networks.

The neural network parameters of the learnable blocks illustrated in FIG. 8 may be learned through a loss function and a backpropagation algorithm.

Meanwhile, in neural network-based image encoding/decoding, a gain unit (GU) and an inverse gain unit (IGU) may be used to support variable bit rate encoding/decoding.

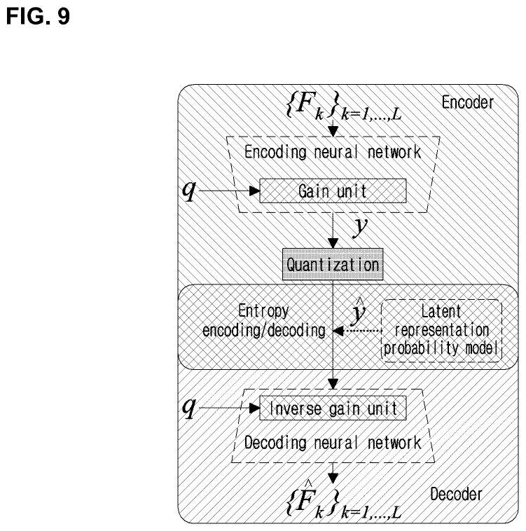

FIG. 9 is a diagram illustrating a multi-layer feature map encoding/decoding process based on a neural network including a gain unit and an inverse gain unit.

As in the example illustrated in FIG. 9, the gain unit may be located at the end of the encoding neural network. On the other hand, the inverse gain unit may be located at the beginning of the decoding neural network.

The gain unit may scale each channel of the input feature map using one of Q gain vectors {v_{q}} (GV: Gain Vector, q is 1 to Q) for variable bit rate encoding. Here, the integer q represents a bit rate level, and Q represents the number of bit rate levels for variable bit rate encoding. q may have a value greater than 0.

The gain unit may scale the latent representation (hereinafter referred to as intermediate latent representation T) immediately before passing through the gain unit according to the following equation 1.

$$y [ c ] [ h ] [ w ] = τ [ c ] [ h ] [ w ] \times {ν}_{q} [ c ] \qquad [ Equation 1 ]$$

In the above equation 1, c (having values from 1 to C) represents a channel index of the intermediate latent representation τ. The length of the gain vector may be equal to C. h (having values from 1 to H) and w (having values from 1 to W) represent vertical and horizontal coordinates of the intermediate latent representation τ, respectively. H and W may represent the height and width of the feature map.

The inverse gain unit may scale each channel of the input feature map using one of the inverse gain vectors {u_{q}} (q is 1 to Q) corresponding to the gain vector.

The intermediate latent representation n output from the inverse gain unit may be obtained through a scaling process as in the following equation 2.

$$η [ c ] [ h ] [ w ] = \hat{y} [ c ] [ h ] [ w ] \times {u}_{q} [ c ] \qquad [ Equation 2 ]$$

In the above equation 2, c (having values from 1 to C) represents the channel index of the quantized latent representation ŷ. The length of the inverse gain vector may be equal to C. h (having values from 1 to H) and w (having values from 1 to W) represent the vertical and horizontal coordinates of the intermediate latent representation ŷ, respectively. H and W may represent the height and width of the feature map.

Each component value of the gain vector and inverse gain vector pair (v_{q}, u_{q}) may be optimized through learning to satisfy the bit rate constraint corresponding to the given bit rate level q.

As a result, the bit rate and the restored image quality of the current image to be encoded may be determined according to the bit rate level q given to the gain unit and the inverse gain unit.

As described above, encoding of a neural network-based multi-layer feature map may be configured through neural networks composed of learnable parameters. An encoding model including the above neural networks may be called a neural network-based multi-layer feature map encoding model.

Meanwhile, the learning of the neural network may be based on a backpropagation algorithm. Through the backpropagation algorithm, the parameters and weights of the neural network may be updated to minimize a specific loss function calculated from learning data.

When learning a neural network-based multi-layer feature map encoding model, a rate-distortion optimization method or a rate-performance optimization method may be used.

The rate-distortion optimization method is to perform learning so as to simultaneously minimize the distortion, between the input multi-layer feature map and the restored multi-layer feature map, and the bit rate of the bit stream, transmitted from the encoder to the decoder.

The rate-performance optimization method is to learn to simultaneously minimize the performance of machine tasks, performed based on the restored multi-layer feature map, and the bit rate of the bitstream, transmitted from the encoder to the decoder.

The distortion loss function used in the neural network-based multi-layer feature map encoding model may be obtained by a weighted sum of the mean square error (MSE) or MS-SSIM (Multi-Scale Structural Similarity Index Measure) between the input multi-layer feature map {Fₖ} and the restored multi-layer feature map { [symbol] }, as in Equation 3.

Meanwhile, when calculating the weighted sum, the weight wₖ may be set individually for each layer.

$${L}_{D} = {E}_{x ∼ {p}_{x}} ( {\sum }_{k = 1 , … , L} {w}_{k} \times D ( {F}_{k} , {\hat{F}}_{k} ) ) \qquad [ Equation 3 ]$$

In the above equation 3, D represents a distortion function such as MSE or MS-SSIM.

The bit rate may be approximated by the cross-entropy between the probability distribution of the latent representation estimated by the latent representation probability model and the actual latent representation. Equation 4 shows an example of calculating the bit rate.

$${L}_{R} = {E}_{x ∼ {p}_{x}} ( - log {p}_{\hat{y}} ( \hat{y} ) ) \qquad [ Equation 4 ]$$

The machine task loss function Lₚ represents the performance of the machine task performed by the compressed and restored multi-layer feature map. The machine task performance may be calculated by comparing the correct answer label and the inference result of the machine task.

At this time, at least one of the classification loss function, the bounding box loss function, or the mask loss function may be used depending on the type of the machine task. However, embodiments according to the present disclosure may be performed based on a loss function of a different type than enumerated ones.

The loss function L_{RD} for rate-distortion optimization may be obtained based on the distortion loss function L_{D} and the cross entropy-based loss function L_{R}. As an example, equation 5 shows an example of deriving the loss function L_{RD}.

$${L}_{R D} = {L}_{R} + λ \times {L}_{D} \qquad [ Equation 5 )$$

Meanwhile, in deriving the loss function L_{RD}, a variable λ may be used to adjust the ratio between the distortion loss function L_{D} and the cross entropy-based loss function L_{R}. Based on the variable λ, the desired restoration quality level and bit rate may be determined. For example, the larger the value of the variable λ, represents the higher the restoration quality level.

The loss function L_{RP} for rate-performance optimization may be obtained according to Equation 6.

$${L}_{R P} = {L}_{R} + λ \times {L}_{P} \qquad [ Equation 6 ]$$

As in the example of equation 6, the loss function L_{RP} may be obtained based on the performance loss function L_{P} and the cross entropy-based loss function L_{R}.

Meanwhile, in deriving the loss function L_{RP}, a variable A may be used to adjust the ratio between the performance loss function L_{P} and the cross entropy-based loss function L_{R}. Based on the variable λ, a desired restoration quality level and bit rate may be determined. For example, the larger the value of the variable λ, represents the higher the machine task performance.

An image or a feature map image may be compressed using a neural network based on convolution or multi-perceptron.

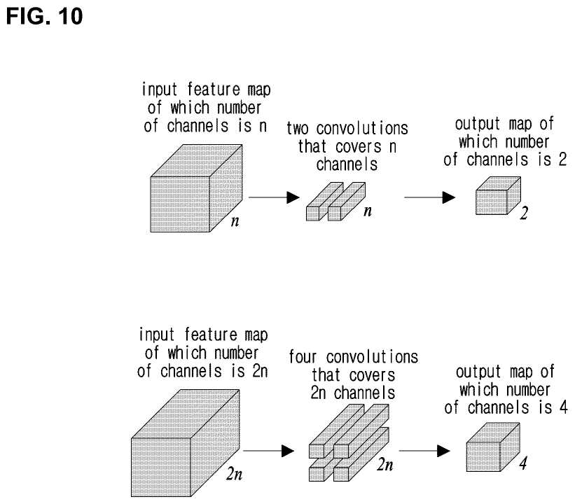

FIG. 10 shows an example of an image or a feature map image being compressed by a convolution-based neural network.

FIG. 10(a) shows a convolution-based neural network in which the number of input channels is n and the number of output channels is 2, and FIG. 10(b) shows a convolution-based neural network in which the number of input channels is 2n and the number of output channels is 4.

If the number of input channels is different from that of output channels, the depth of the convolution kernel or the number of convolution kernels may also be different.

For example, when a feature map having n channels is input, a convolution with a depth of n is required, and in order to output a feature map having 2 channels, 2 convolution kernels are required.

Similarly, when a feature map having 2n channels is input, a convolution with a depth of 2n is required, and in order to output a feature map having 4 channels, 4 convolution kernels are required.

That is, the depth of the convolution may be determined according to the number of channels of the input feature map, and the number of convolution kernels may be determined according to the number of feature maps being output.

Accordingly, the single convolution kernel cannot be used for cases where the number of channels of the input and/or output feature maps is different.

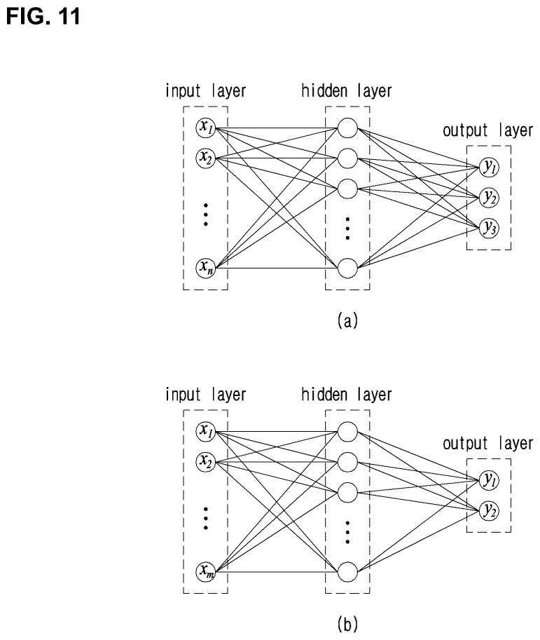

FIG. 11 shows an example of compressing an image or a feature map image using a multilayer perceptron-based neural network.

FIG. 11(a) shows a multilayer perceptron-based neural network in which the number of input layer nodes is n and the number of output layer nodes is 3, and FIG. 11(b) shows a multilayer perceptron-based neural network in which the number of input layer nodes is m and the number of output layer nodes is 2.

When the number of input layer nodes is n, as many weights to connect the n input layer nodes to hidden layer nodes are required, and when the number of input layer nodes is m, as many weights to connect the m input layer nodes to hidden layer nodes are required.

In other words, the number of required weights varies depending on the number of input layer nodes or the number of output layer nodes. Accordingly, the single multi-perceptron neural network cannot be used for cases where the number of input layer nodes and/or output layer nodes is different.

That is, as in the examples illustrated in FIGS. 10 and 11, in the case of a neural network-based compression model, at least one of the kernel depth of a module in charge of input or output in the neural network model, the number of kernels, or the number of weights connecting nodes is determined according to the number of channels of the input feature map or the output feature map. Accordingly, it is necessary to individually construct a neural network model according to the number of channels of the input feature map or the output feature map.

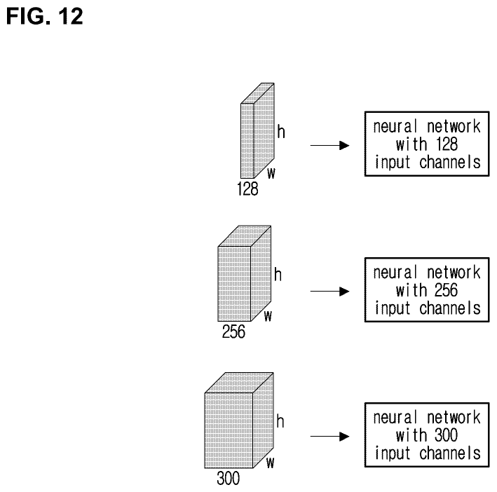

FIG. 12 shows an example in which a neural network-based compression model is defined according to the number of channels of an input feature map.

In order to solve the above problem, this disclosure proposes a single neural network model that is adaptive to the number of channels of an input feature map.

The number of channels of feature maps extracted from various machine vision task models may be different from each other.

In addition, even if the same machine vision task is targeted, the number of channels of feature maps to be encoded may be different depending on the type of model.

In addition, even within a single model, the number of channels of feature maps may vary depending on whether a layer in which a feature map is included.

In this disclosure, a method for transforming and reconstructing a latent representation for an input feature map is proposed based on a single feature map encoding neural network structure. At this time, at least one of the number of layers or the number of channels of feature maps input to the single feature map encoding neural network structure may be different.

In the present disclosure, a single feature map encoding neural network structure represents a combination of a channel-separable latent representation transform unit and a channel-separable feature map reconstruction unit.

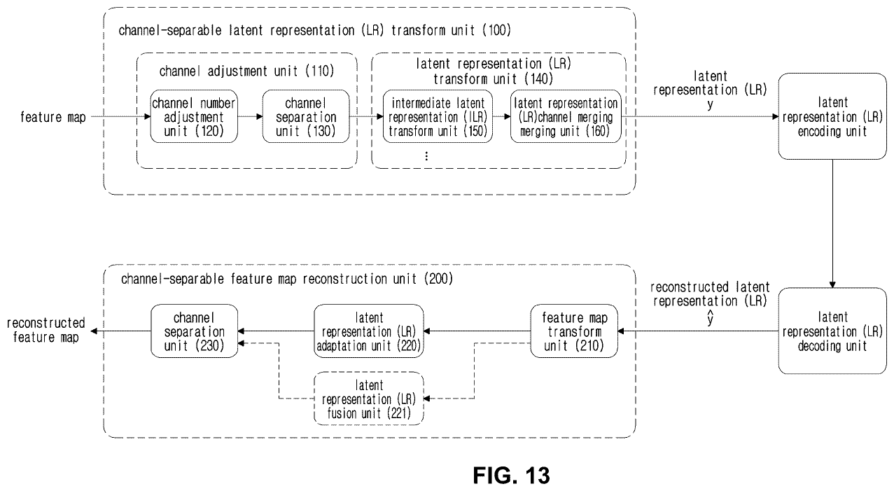

FIG. 13 is a block diagram of a device including a neural network structure for feature map encoding/reconstructing according to one embodiment of the present disclosure.

Referring to FIG. 13, the device may include a channel-separable latent representation transform unit 100 and a channel-separable feature map reconstruction unit 200.

Meanwhile, each functional unit illustrated in FIG. 13 may be implemented through a plurality of devices. For example, the feature map encoding side (i.e., the encoder side) may be configured to include a channel-separable latent representation transform unit 100, while the encoded feature map decoding side (i.e., the decoder side) may be configured to include only a channel-separable feature map reconstruction unit 200. Meanwhile, the encoder side may be configured to further include a channel-separable feature map reconstruction unit 200 in addition to the channel-separable latent representation transform unit 100. The channel-separable latent representation transform unit 100 may include at least one of a channel adjustment unit 110 and a latent representation transform unit 140.

The channel adjustment unit 110 may include at least one of a channel number adjustment unit 120 and a channel separation unit 130, and the latent representation transform unit 140 may include at least one of an intermediate latent representation transform unit 150 and a latent representation channel merging unit 160.

The channel-separable feature map reconstruction unit 200 may include at least one of a feature map transform unit 210, a latent representation adaptation unit 220, and a channel separation unit 230.

Meanwhile, instead of the latent representation adaptation unit 220, the channel-separable feature map reconstruction unit 200 may be configured using a latent representation fusion unit 221.

Hereinafter, each component will be examined in detail.

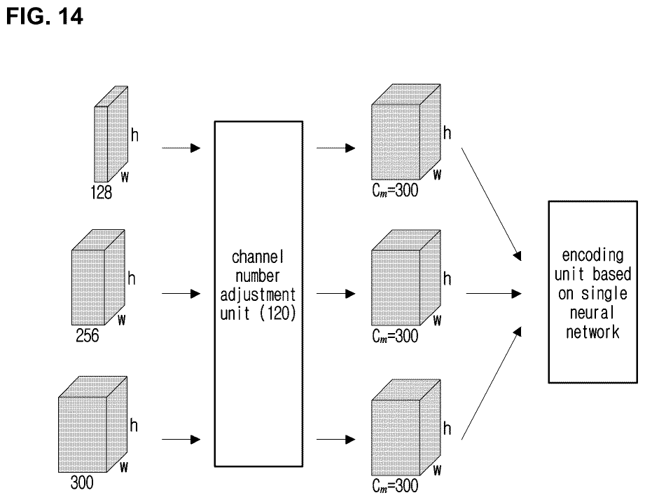

FIG. 14 illustrates a neural network-based compression model including a channel number adjustment unit according to one embodiment of the present disclosure.

The channel number adjustment unit 120 adjusts the number of channels of input feature maps to be the same. Specifically, the reference number is set to the same as the number of channels of the feature map with the largest number of channels (e.g., Cₘ) among the multiple feature maps input to the neural network. Thereafter, the number of channels of the feature maps with a channel number smaller than the reference number is adjusted to have the reference number of channels.

Accordingly, the feature maps output from the channel number adjustment unit 120 may be composed of channels with the reference number (i.e., Cₘ).

Meanwhile, at least one of the channel separation unit 130 or the intermediate latent representation transformation unit 150 may be added for efficient operation of a single neural network model.

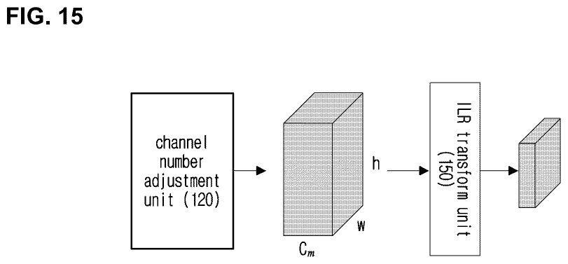

FIGS. 15 to 17 illustrate a neural network-based compression model to which at least one of an intermediate latent representation transform unit or a channel separation unit is added according to one embodiment of the present disclosure.

As in the example illustrated in FIG. 15, a feature map output from a channel number adjustment unit 120 (i.e., a feature map adjusted to have a reference number of channels) may be input to an intermediate latent representation transform unit 150. In this case, the intermediate latent representation transform unit 150 may be designed to receive a feature map having as many channels as the reference number.

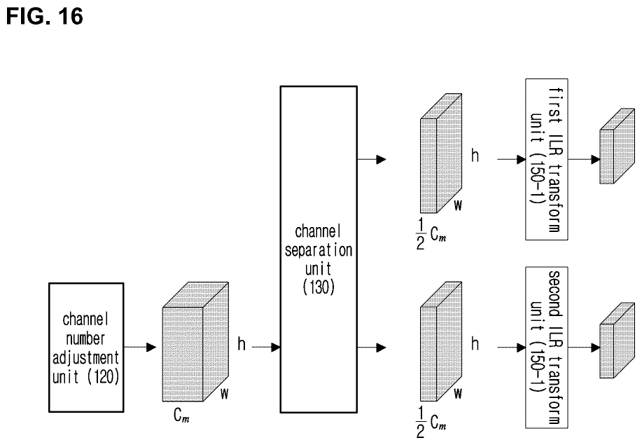

The channel separation unit 130 may separate the input feature map into n^{l} channel groups. As an example, in FIG. 16, the input feature map is separated into two (i.e., n^{l}=2) channel groups.

At this time, the number of channels in each channel group may be the same or different. For convenience of explanation, it is assumed that the number of channels in each channel group is the same. For example, in FIG. 16, each channel group is illustrated as consisting of Cₘ/2 channels.

Each of the channel groups output from the channel separation unit 130 may be input to the latent representation transform unit 150. In this case, the intermediate latent representation transform unit 150 should be designed so that it can receive the number of channels of the channel group (i.e., Cₘ/2).

If the number of channel groups is smaller than the number of intermediate latent representation transform units, the channel groups may be input only to some intermediate latent representation transform units.

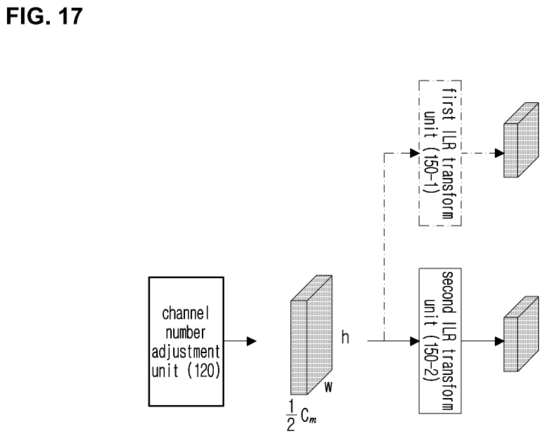

For example, as in the example illustrated in FIG. 17, if there are two intermediate latent representation transformation units 150-1 and 150-2 but the number of channel groups is 1, a feature map may be input to only one of the two intermediate latent representation transformation units 150-1 and 150-2. For example, in the example illustrated in FIG. 17, a feature map having Cₘ/2 channels is exemplified as being input to the second intermediate latent feature transformation unit 150-2 among the two intermediate latent representation transformation units 150-1 and 15-2.

After separating the feature map into a plurality of channel groups through the channel separation unit 130, each of the separated channel groups may be input to an individual intermediate latent representation transformation unit 150. Accordingly, the number of latent representations output from the intermediate latent representation transform units 150-1 and 150-2 is equal to the number of channel groups (i.e., n^{l}). When n^{l} intermediate latent expressions (i.e., {z₁^{l}, . . . , z_{N}_{^{l}}^{l}}) are obtained, the obtained intermediate latent representations may be merged into one latent representation through the latent representation channel merging unit 160.

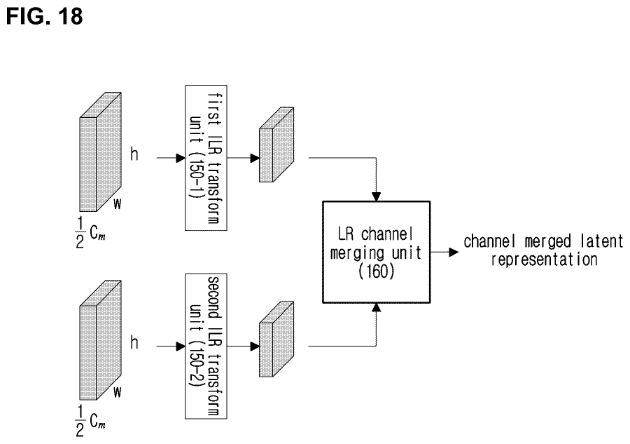

FIG. 18 illustrates a neural network-based compression model including a latent representation channel merging unit according to one embodiment of the present disclosure.

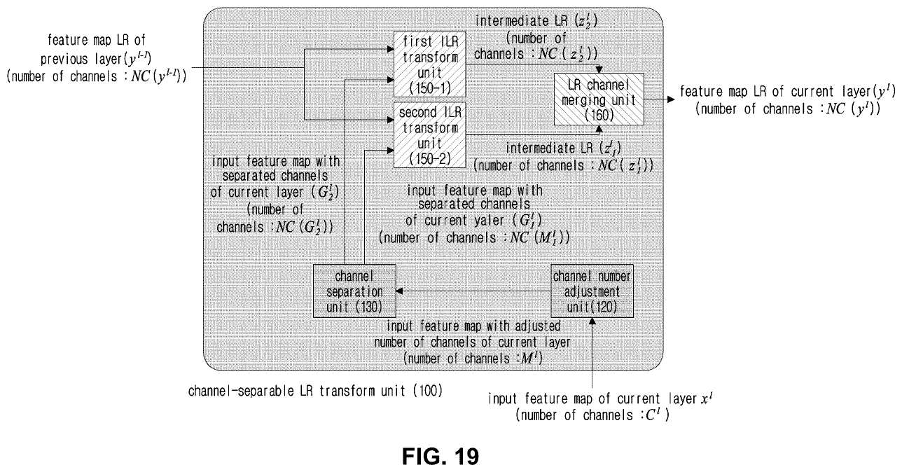

FIG. 19 illustrates an example for explaining the overall operations of a channel-separable latent representation transform unit.

In the channel-separable latent representation transform unit 100, the channel number adjustment unit 120 may adjust the number of channels C^{l} of the current layer feature map to the reference number M^{l}. Meanwhile, the number of channels C^{l} of the current layer feature map may be equal to or smaller than the reference number M^{l}.

The channel separation unit 130 may separate the current layer feature map with the adjusted number of channels into a plurality of channel groups (i.e., N^{l} channel groups).

The intermediate latent representation transform unit 150-1 or 150-2 may generate an intermediate latent representation by merging an input channel group with a latent representation of a previous layer feature map.

The latent representation channel merging unit 160 may merge intermediate latent representations output from the intermediate latent representation transform units into a single latent representation and output a feature map latent representation of a current layer.

According to the present disclosure, input feature maps having different numbers of channels may be processed as a single neural network model through a neural network-based compression device.

In the case where multiple feature maps (i.e., a multi-layer feature map) other than a single layer feature map are input, the number of channel-separable latent representation transform units 100 may be used as many as the number of feature maps (i.e., the number of layers).

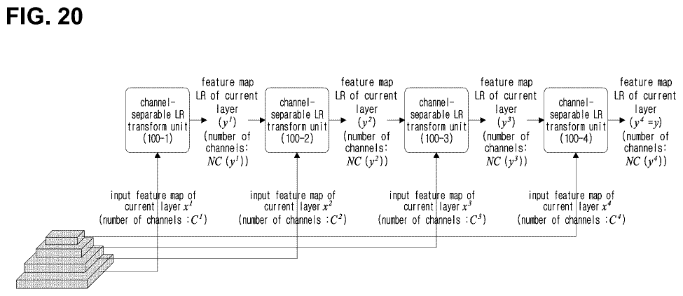

FIG. 20 shows an example of using multiple channel-separable latent representation transform units.

When a multi-layer feature map is input, the number of channel-separable latent representation transform units may be used as many as the number of layers. For example, when the number of layers of the multi-layer feature map is 4, 4 channel-separable latent representation transform units 100-1, 100-2, 100-3 and 100-4 may be used.

Each of the layers may be input to a corresponding channel-separable latent representation transform unit 100, and the channel-separable latent representation transform units 100-2, 100-3 and 100-4, other than the first channel-separable latent representation transform unit 100-1 into which the first layer is input, may receive the output of the channel-separable latent representation transform unit into which the previous layer feature map is input, as well as the feature map of a corresponding layer.

The latent representation output through the last channel-separable latent representation transform unit 100-4 may be used as the final latent representation y.

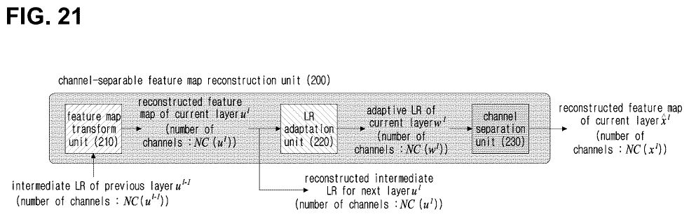

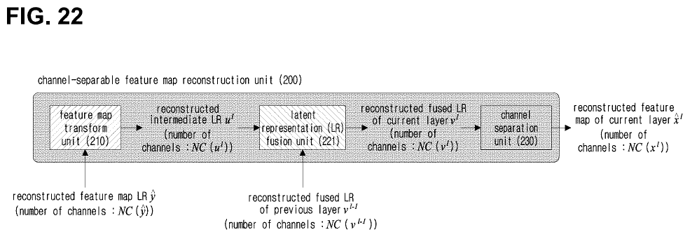

FIGS. 21 and 22 illustrate detailed operations of a channel-separable feature map reconstruction unit.

Through the channel-separable feature map reconstruction unit, output feature maps with different numbers of channels may be processed as a single neural network model.

Specifically, the feature map transform unit 210 in the channel-separable feature map reconstruction unit 200 may transform the reconstructed feature map latent representation into an intermediate latent representation.

FIG. 21 illustrates detailed operations of a channel-separable feature map reconstruction unit including a latent representation adaptation unit.

The latent representation adaptation unit 220 may receive the reconstructed intermediate latent representation and obtain an adaptive latent representation for the current layer.

Meanwhile, when there are multiple latent representation adaptation units, the latent representation adaptation unit may not be used for the last layer.

The latent representation adaptation unit 220 may also be replaced with a latent representation fusion unit 221.

FIG. 22 illustrates the detailed operation of a channel-separable feature map reconstruction unit including a latent representation fusion unit.

In the case where there are multiple latent representation fusion units, the latent representation fusion units except for the first latent representation fusion unit may additionally receive a fused latent representation output from the previous layer.

The channel separation unit 230 may perform channel separation from the adaptive/fused latent representation to obtain a reconstructed feature map for the current layer. Specifically, channels may be separated from the adaptive/fused latent representation according to the number of channels of the feature map to be reconstructed.

In the case where the feature map to be processed is a single-layer, only one channel-separable latent representation restoration unit may be used. On the other hand, in the case where there are multiple feature maps to be processed (i.e., a multi-layer feature map), the number of latent representation reconstruction units 200 corresponding to the number of feature maps (i.e., the number of layers) may be used.

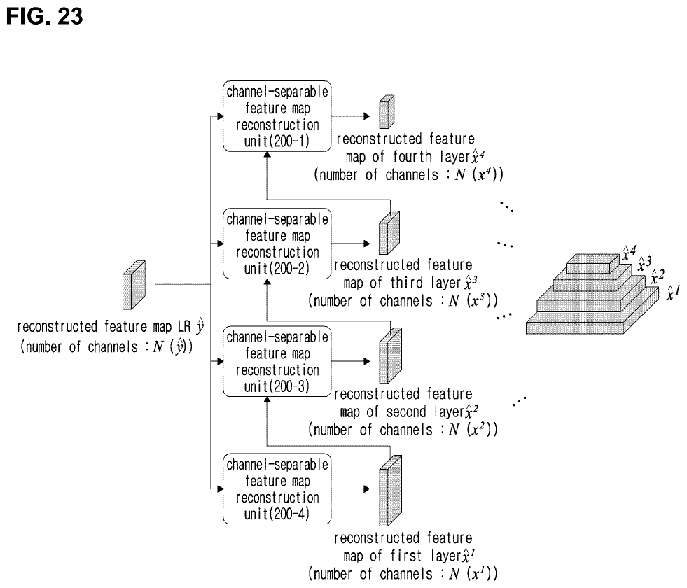

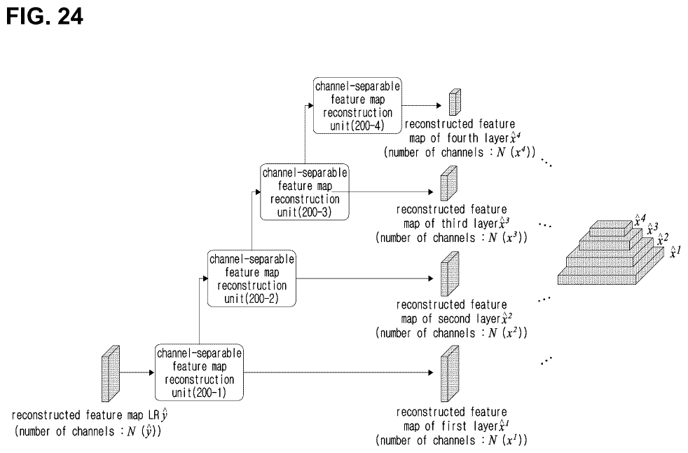

FIGS. 23 and 24 illustrate examples of using channel-separable latent representation reconstruction units as many as the number of layers.

Since the multi-layer feature map to be reconstructed has four layers, four channel-separable feature map restoration units 200-1, 200-2, 200-3 and 200-4 may be used.

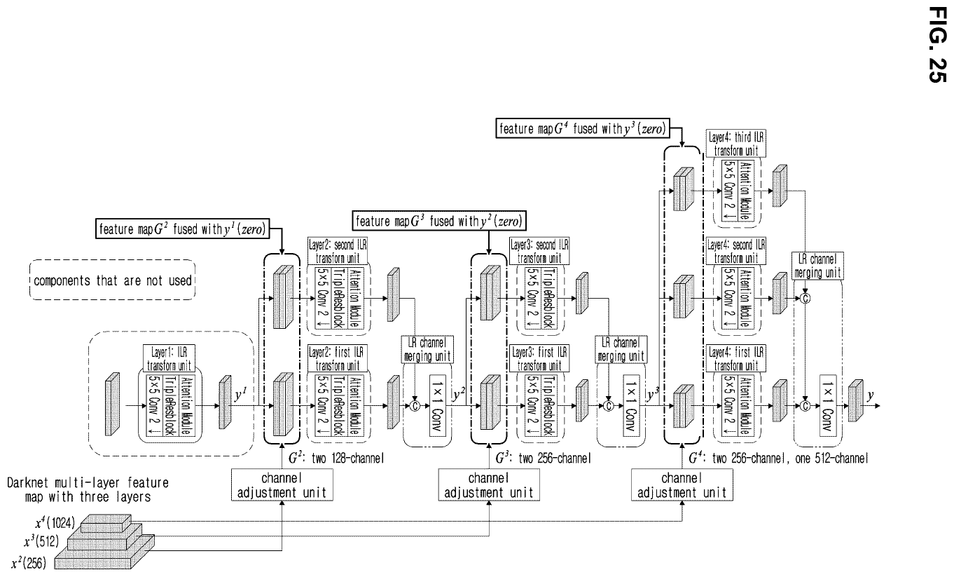

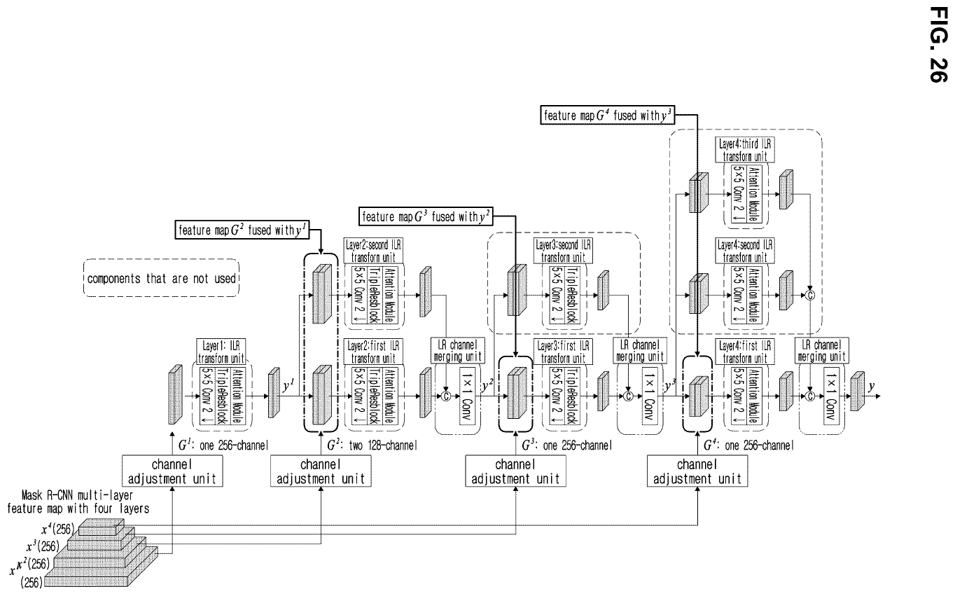

FIGS. 25 and 26 illustrate examples of generating feature map latent representations in a channel-separable latent representation transformation unit.

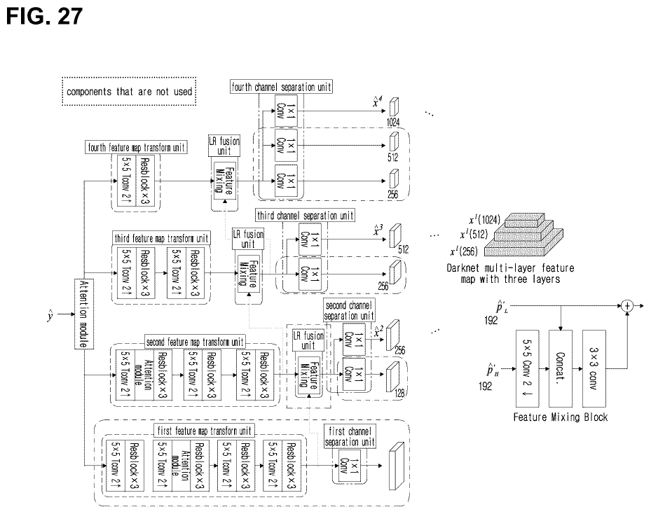

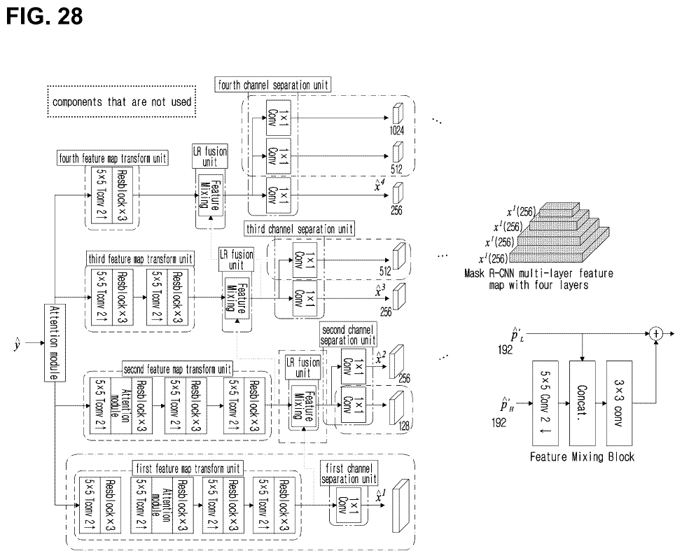

And, FIGS. 27 and 28 illustrate examples of reconstructing feature maps in parallel in a channel-separable feature map reconstruction unit.

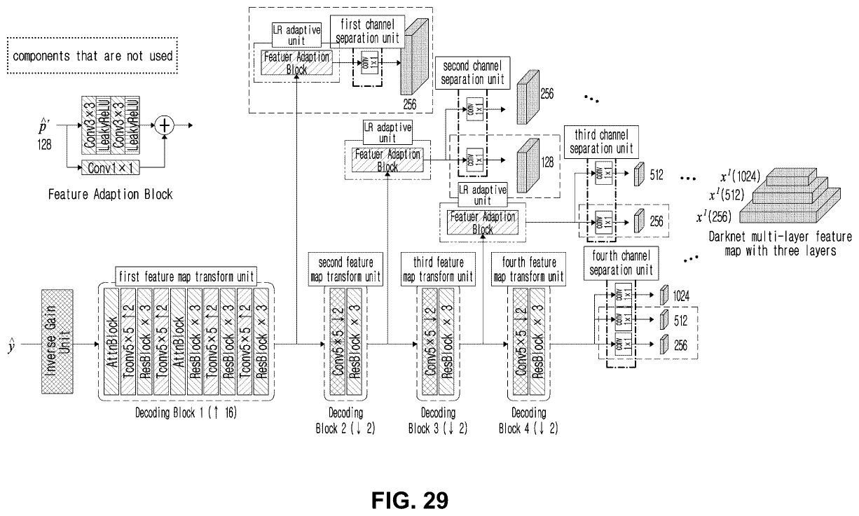

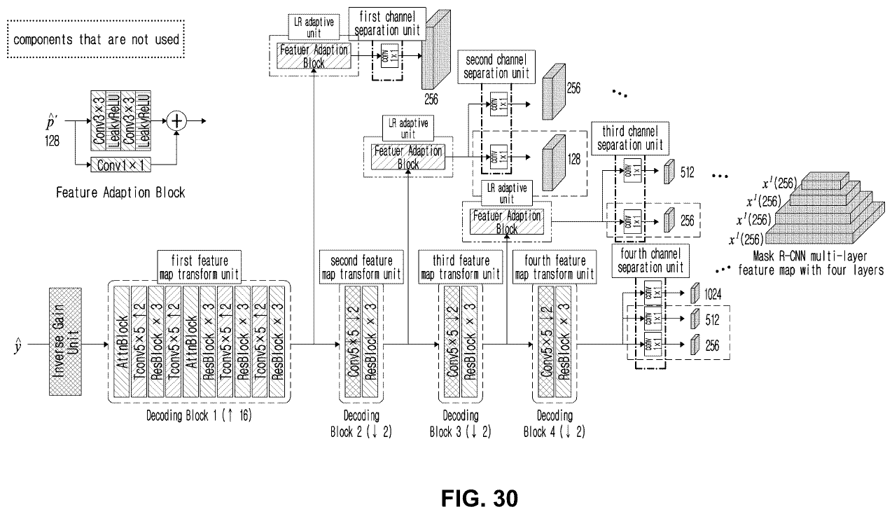

And, FIGS. 29 and 30 illustrate examples of reconstructing feature maps sequentially in a channel-separable feature map reconstruction unit.

In FIGS. 25 and 26, it is illustrated that there are four channel-separable latent representation transformation units.

Also, in FIGS. 27 to 30, it is illustrated that there are four channel-separable feature map reconstruction units. Accordingly, in the illustrated examples, multi-layer feature maps of four layers may be processed.

Meanwhile, in FIG. 25, it is assumed that the input feature maps are composed of three layers. In addition, the number of channels of each of the three layers is exemplified as 256, 512, and 1024.

In this case, the first channel-separable latent representation transform unit (i.e., layer 1) among the four intermediate latent representation transform units may not be used. Specifically, the feature maps with the first layer (x²), the second layer (x³), and the third layer (x⁴) may be input to the second to fourth intermediate latent representation transform units, but none of information of the feature map may be input to the first latent representation transform unit.

In this case, the output value of the first intermediate latent representation transform unit may be set to 0 (i.e., an array padded with 0), and the output value of 0 may be input to the next intermediate latent representation transform unit (i.e., layer 2). Similarly, in FIG. 27, the number of feature maps to be reconstructed (i.e., the number of layers) is exemplified as 3. Accordingly, the first channel-separable feature map reconstruction unit (i.e., layer 1) may not be used.

Similarly, in FIG. 29, the number of feature maps to be reconstructed (i.e., the number of layers) is exemplified as 3. Accordingly, the first latent representation adaptation unit and the first channel separation unit may not be used.

In the example illustrated in FIG. 26, the multi-layer feature map is illustrated as consisting of four layers, and each of the four layers is illustrated as consisting of 256 channels.

In the example illustrated in FIG. 26, the third channel-separable latent representation transform unit (i.e., layer 3) may input/output 512 channels, and the fourth channel-separable latent representation transform unit (i.e., layer 4) may input/output 1024 channels. However, since each layer is composed of 256 channels, in the third channel-separable latent representation transform unit, only the first intermediate latent representation transform unit may be used, and the second intermediate latent representation transform unit may not be used, and in the fourth channel-separable latent representation transform unit, only the first intermediate latent representation transform unit may be used, and the second and third intermediate latent representation transform units may not be used.

Likewise, in FIG. 28, the number of feature maps to be reconstructed (i.e., the number of layers) is 4, and the number of channels in each layer is 256. Accordingly, at least one channel separation unit in the second, third, and fourth channel-separable feature map reconstruction units may not be used.

Next, embodiments of a feature map encoding and decoding method according to the present disclosure will be described in detail.

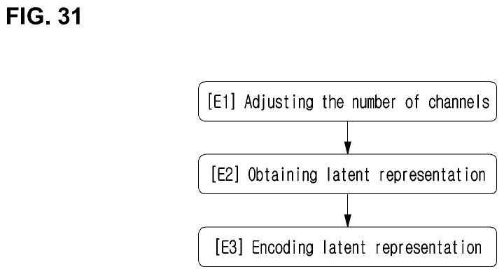

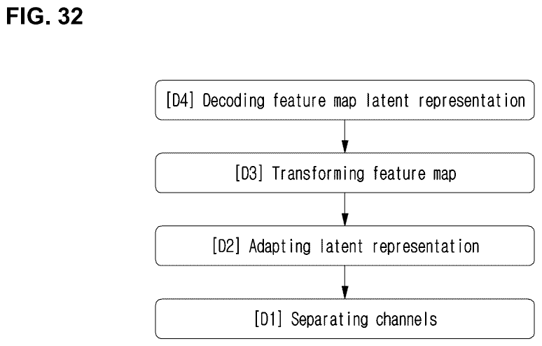

FIG. 31 is a flow chart of a method of encoding a feature map according to an embodiment of the present disclosure, and FIG. 32 is a flow chart of a method of decoding a feature map according to an embodiment of the present disclosure.

Referring to FIG. 31, the method of encoding a feature map may include a step of adjusting channels [E1], a step of obtaining latent representation [E2], and a step of encoding latent representation [E3]. Meanwhile, steps [E1] and [E2] may be performed by a channel-separable latent representation transformation unit 100 according to the present disclosure.

The channel-separable latent representation transformation unit 100 receives a feature map of a current layer and a latent representation of a previous layer feature map as inputs, and outputs a latent representation of a feature map of the current layer.

The channel-separable latent representation transformation unit 100 may be used as many times as the number of input feature maps (i.e., the number of layers).

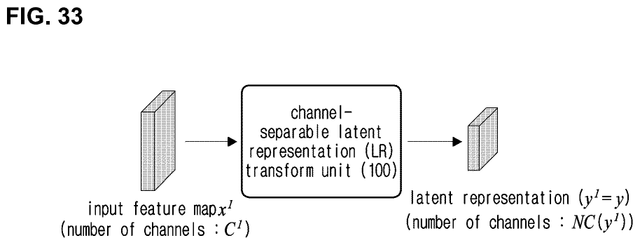

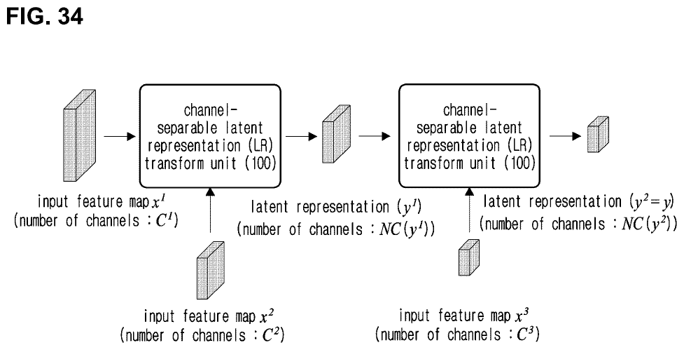

FIG. 33 shows an example of a case where a single-layer feature map is input, and FIG. 34 shows an example of a case where a multi-layer feature map is input.

As in FIG. 33, when a single-layer feature map is input, one channel-separable latent representation transform unit 100 may be used. When a single-layer feature map is input, the latent representation of the previous layer feature map may not be used.

As in FIG. 34, when a multi-layer feature map is input, as many channel-separable latent representation transform units 100 as the number of layers may be used. The output of the last channel-separable latent representation transform unit may be set as the final latent representation. The final latent representation may be used as the input of the latent representation encoding unit.

Referring to FIG. 32, a method of decoding a feature map may include a step of decoding feature map latent representation [D4], a step of transform feature map latent representation [D3], a step of adapting/fusing latent representation [D2], and a step of channel separation [D1]. Meanwhile, steps [D1], [D2], and [D3] may be performed by a channel-separable feature map reconstruction unit 200 according to the present disclosure.

The channel-separable feature map reconstruction unit 200 may be used to reconstruct a feature map of a specific layer. That is, in order to reconstruct a single-layer feature map, one channel-separable feature map reconstruction unit 200 may be used. On the other hand, in order to reconstruct a multi-layer feature map, as many channel-separable feature map reconstruction units 200 as the number of layers may be used.

Hereinafter, each step will be described in detail.

### [E1] Step of Adjusting Channels of Input Feature Map

The present step may include a step of adjusting the number of channels [E1-1] and a step of separating the feature map into multiple channel groups [E1-2]. Meanwhile, the steps [E1-1] and [E1-2] may be performed by a channel number adjustment unit 120 and a channel separation unit 130, respectively.

Through the present step, a feature map corresponding to the current layer l having C^{l} channels may be separated into N^{l} channel groups.

Specifically, the channel number adjustment unit 120 may adjust the number of channels of feature maps that the number of channels are different from each other to a constant number. The feature map with the adjusted number of channels is input to the channel separation unit 130, and the channel separation unit 130 may separate the input feature map into multiple channel groups.

Meanwhile, the adjustment of the number of channels may be performed through a convolution kernel or channel padding.

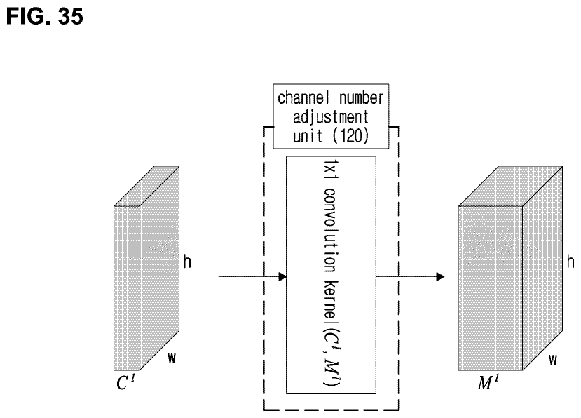

FIG. 35 shows an example in which the number of channels is adjusted based on a convolution kernel.

As shown in the example in FIG. 35, a feature map composed of C^{l} channels may be converted into a feature map composed of M^{l} channels (where M^{l} is equal to or greater than C^{l}) based on a convolution kernel with a size of 1×1.

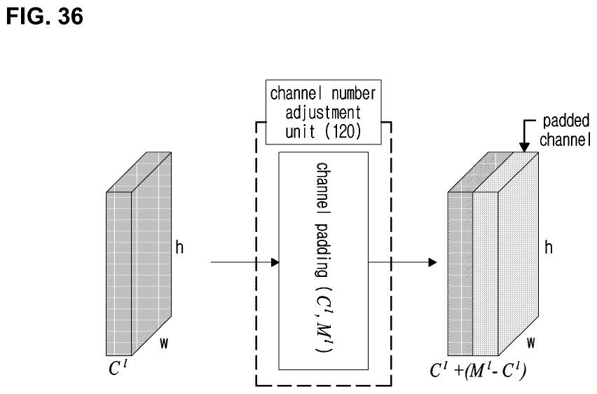

FIG. 36 shows an example in which the number of channels is adjusted through channel padding.

When the target number of channels M^{l} and the number of current input channels C^{l} are different, channels as many as the difference between the target number of channels and the number of current input channels (i.e., M^{l}-C^{l}) may be generated through padding. Meanwhile, padding may include at least one of setting the values of all elements (or pixels) in a channel to 0, setting the values of all elements in a channel to a specific value, or copying at least one of the current input channels to a new channel.

Hereinafter, a detailed method for adjusting the number of channels will be described.

### [E1-1] Adjusting the Number of Channels of the Feature Map

The channel number adjustment unit (120) adjusts the number of channels of the input feature map having C^{l} channels to M^{l}. Here, M^{l} may be referred to as the target number or the reference number.

Meanwhile, whether to apply the present step (i.e., the channel number adjustment unit (120)) or not may be determined by comparing the channel number C^{l} of the input feature map with the target number M^{l}.

The target number M^{l} may be set to a value equal to or greater than the number of channels of the feature map having the largest number of channels among the input feature maps. At this time, the channel number C^{l} of the input feature map and the target number M^{l} are compared and if they are the same (i.e., C^{l}=M^{l}), the present step may be skipped.

Even in the same layer, the number of channels may be different depending on the type of the feature map, or, even within a multi-layer feature map, the number of channels may be different between layers. When adjusting the number of channels based on the convolution kernel, multiple convolution kernels may be used. And, through the channel adjustments, multiple feature maps with different numbers of channels may be adjusted to have the same number of channels. Here, the multiple feature maps with different numbers of channels may represent intermediate feature maps output from various machine vision task models, or feature maps of different layers output from the same machine vision task model.

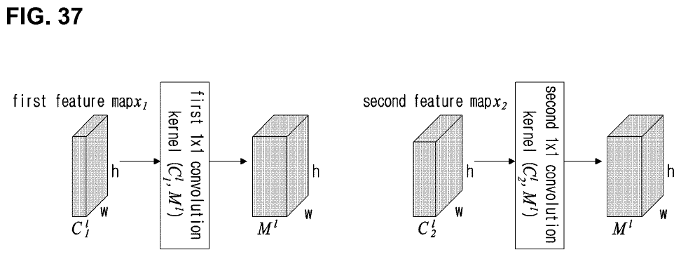

FIG. 37 shows an example of adjusting the number of channels of intermediate feature maps output from various machine vision models to be the same.

It is assumed that the number of channels of the first feature map x₁ output from the first machine vision task model is C₁^{l}, and the number of channels of the second feature map x₂ output from the second machine vision task model is C₂^{l}. At this time, the first feature map x₁ may be input to a convolution kernel that adjusts the number of channels C₁^{l} to the target number M^{l}, and the second feature map x₂ may be input to a convolution kernel that adjusts the number of channels C₂^{l} to the target number M^{l}. Accordingly, the number of channels of the first feature map and the second feature map may be adjusted to be the same.

Meanwhile, the target number M^{l} may satisfy the following equation 7.

$${M}^{l} = {\sum }_{i = 1}^{{N}^{l}} {α}^{i} N C ( {G}_{i}^{l} ) , ( {α}_{i}^{l} ∈ \{ 0 , 1 \} ) \qquad [ Equation 7 ]$$

In the equation 7, NC(Gᵢ^{l}) represents the number of channels of the i-th group of the current layer l.

Meanwhile, in the above-described example, it was exemplified that the first feature map x₁ having the number of channels C₁^{l} and the second feature map x₂ having the number of channels C₂^{l} are adjusted to have the target number of channels M^{l}.

Unlike the described example, the target number of channels may be set differently for each input feature map. For example, the number of channels C₁^{l} of the first feature map x₁ may be adjusted to the first target number M₁^{l}, and the number of channels C₂^{l} of the second feature map x₂ may be adjusted to the second target number M₂^{l}.

Setting the target number of channels equally or differently for feature maps may also be applied to the method of adjusting the number of channels based on padding.

[E1-2] Separating Feature Map into Multiple Channel Groups

A feature map adjusted to have a target number of channels M^{l} may be separated into N^{l} channel groups. Here, N^{l} may be a natural number greater than or equal to 1. On the other hand, if N^{l} is 1, the present step may be skipped.

The number of channels in each of the channel groups may be the same or different. Since a feature map having M^{l} channels is separated into N^{l} channel groups

$$\{ {G}_{1}^{l} , … , {G}_{{N}^{l}}^{l} \} ,$$

the condition of the following equation 8 may be satisfied.

$${\sum }_{n = 1}^{{N}^{l}} ( {G}_{n}^{l} ) = {M}^{l} \qquad [ Equation 8 )$$

In equation 8, NC(Gₙ^{l}) represents the number of channels of the nth channel group.

Each channel group may be used as an input of the intermediate latent representation transform unit 150.

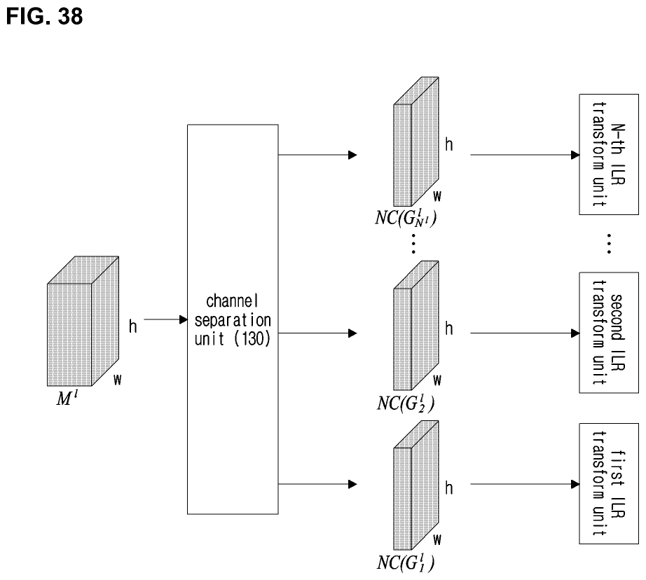

FIG. 38 illustrates an example in which each of a plurality of channel groups, generated through channel separation, is input to the intermediate latent representation transform unit.

Channel separation may be performed based on a convolution kernel.

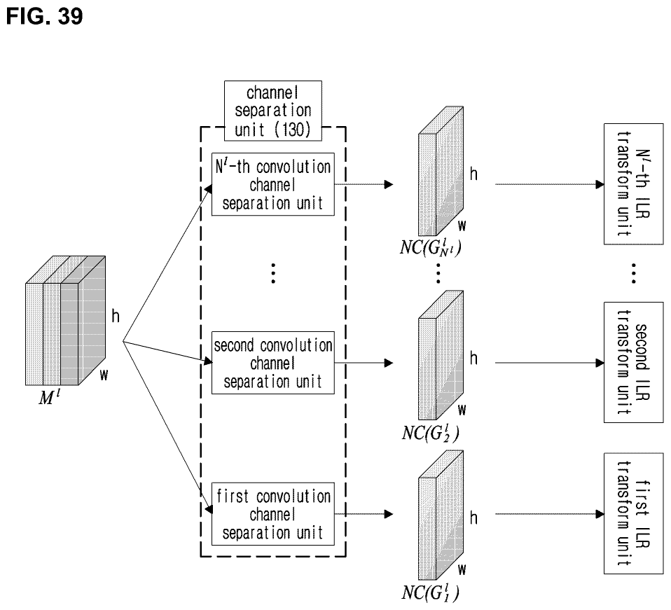

FIG. 39 illustrates an example in which channel separation is performed based on a convolution kernel.

As another example, the separation method may be determined differently depending on the channel order.

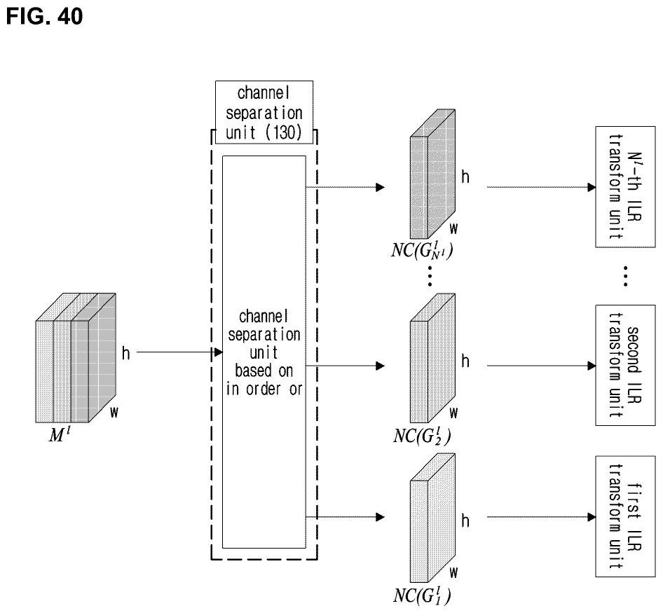

FIG. 40 illustrates an example in which the separation method is determined differently depending on the channel order.

### [E2] Step of Obtaining Latent Representation

The step of obtaining the latent representation is to generate the latent representation y^{l} of the current layer feature map. The present step may include a step of obtaining the intermediate latent representation [E2-1] and a step of merging the latent representation in a channel direction [E2-2]. Each of [E2-1] and [E2-2] steps may be performed by the intermediate latent representation transform unit 150 and the latent representation channel merging unit 160.

The step of adjusting channels may receive separated N^{l} channel groups and the latent representation y^{l-1} of the previous layer feature map to generate the latent representation y^{l} of the current layer feature map.

For the first layer (i.e., l=1), there is no latent representation of the previous layer feature map. Accordingly, only the channel group may be used as input data for the first layer feature map. Alternatively, for the first layer feature map, each element of the latent representation y^{l-1} of the previous layer feature map may be set to a specific constant value (e.g., 0).

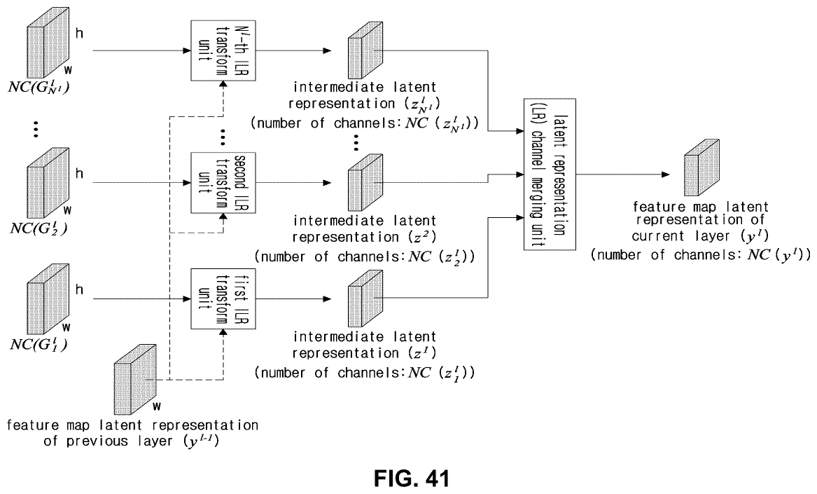

FIG. 41 illustrates an example of the operation of the latent representation transform unit.

As in the example illustrated in FIG. 41, the intermediate latent representation transform unit 150 may receive a channel group and a latent representation of the previous layer feature map. That is, N^{l} intermediate latent representation transform units may be arranged in parallel to perform intermediate latent representation transform for N^{l} channel groups.

The latent representation channel merging unit 160 may merge N^{l} intermediate latent representations

$$\{ {z}_{1}^{l} , … , {z}_{{N}^{l}}^{l} \}$$

output from N^{l} Intermediate latent representation transform units into one latent representation. Accordingly, the latent representation y^{l} of the current layer feature map may be obtained.

### [E2-1] Step of Obtaining Intermediate Latent Representation

The intermediate latent representation transformation units 150 may exist as many as the number of channel groups N^{l} generated in the channel separation unit 130. Accordingly, N^{l} intermediate latent representations

$$\{ {z}_{1}^{l} , … , {z}_{{N}^{l}}^{l} \}$$

may be output from the intermediate latent representation transform units 150.

The intermediate latent representation transform unit 150 is configured to include a connection unit and an intermediate latent representation transform block. Specifically, in the connection unit, the channel group and the feature map latent representation of the previous layer may be connected in the channel direction. Then, by inputting the data connected in the channel direction to the intermediate latent representation transform block, the intermediate latent representation for the input channel group may be obtained.

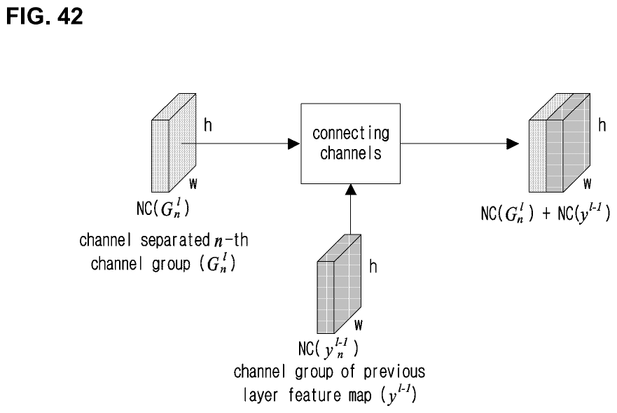

FIG. 42 illustrates an example in which the channel group and the feature map latent representation of the previous layer are connected in the channel direction in the connection unit.

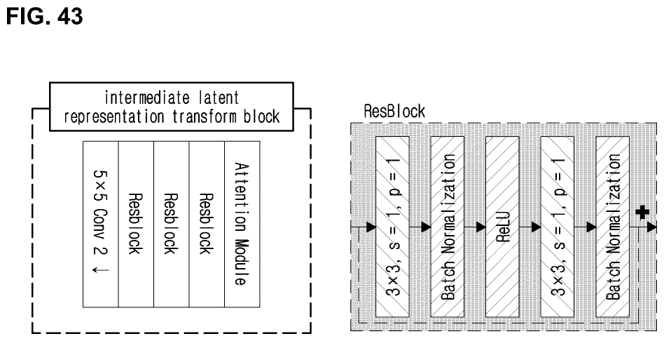

FIG. 43 illustrates an example of a configuration diagram of an intermediate latent representation transform block.

As in the example illustrated in FIG. 43, the intermediate latent representation transform block may have a structure in which convolutional layers and attention blocks are stacked. Alternatively, the intermediate latent representation transform block may be configured by combining conventional neural network-based encoding blocks for image processing.

If the number of intermediate latent representation transform units is greater than the number of channel groups, at least one of the intermediate latent representation transform units may not be used. For example, in Equation 7, if the weight αᵢ^{l} for the i-th channel group of the current layer l is 0, the intermediate latent representation transform unit corresponding to the i-th channel group is not used. In this instance, the weight αᵢ^{l} may be set to 0 or 1. That is, if there is no corresponding channel group for the intermediate latent representation transform unit 150 or the weight of the corresponding channel group is 0, the step of obtaining the intermediate latent representation may be skipped.

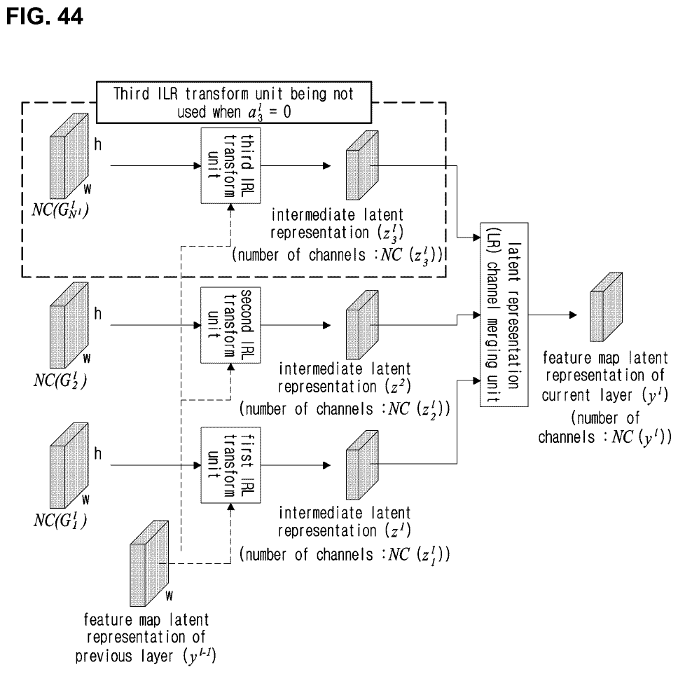

FIG. 44 illustrates a case where at least one of the intermediate latent representation transform units is not used.

In FIG. 44, the number of channel groups N^{l} is 3, the weight α₃^{l} of the third channel group is 0, and, the weights α₁^{l} and α₂^{l} of the first and second channel groups respectively are 1. Accordingly, the intermediate latent representation transform unit 150 corresponding to the third channel group may not be used.

Alternatively, the output value of the intermediate latent representation transform unit 150 corresponding to the channel group with a weight of 0 may be set to 0.

### [E2-2] Step of Merging Latent Representation in Channel Direction

When N^{l} intermediate latent representations

$$\{ {z}_{1}^{l} , … , {z}_{{N}^{l}}^{l} \}$$

are output from N^{l} intermediate latent representation transform units, the intermediate latent representations may be merged to generate the latent representation y^{l} of the feature map of the current layer.

The N^{l} intermediate latent representations

$$\{ {z}_{1}^{l} , … , {z}_{{N}^{l}}^{l} \}$$

may be connected in the channel direction. The number of channels of the intermediate latent representations connected in the channel direction, NC(y^{l}), may be expressed as the following equation 9.

$$( {y}^{l} ) = {\sum }_{n = 1}^{{N}^{l}} ( {z}_{n}^{l} ) \qquad [ Equation 9 )$$

In equation 9, NC(zₙ^{l}) represents the number of channels of the n-th intermediate latent representation.

Thereafter, the channel-connected intermediate latent representations may be input to a 1×1 convolution.

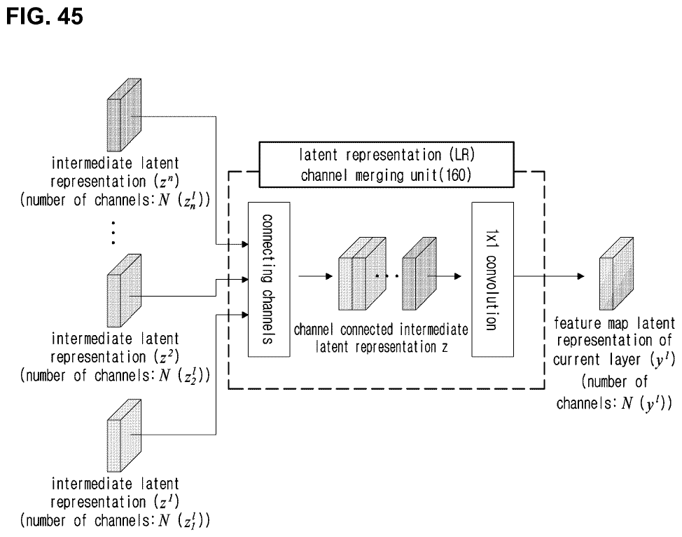

FIG. 45 illustrates a detailed operation of the latent representation channel merging unit.

As described above, the latent representation channel merging unit 160 may connect the intermediate latent representations in the channel direction and input the connected data into a 1×1 convolution.

### [E3] Step of Encoding Feature Map Latent Representation/[D4] Step of Decoding Feature Map Latent Representation

By encoding the feature map latent representation, a bitstream may be generated.

In addition, by decoding the generated bitstream, the feature map latent representation may be reconstructed.

Encoding/decoding of the feature map latent representation may be performed based on an image compression codec or neural network-based entropy encoding/decoding.

An example of an image compression codec may be HEVC or VVC.

### [D3] Step of Transforming Feature Map Latent Representation

The present step may be performed by the feature map transform unit 210. The feature map transform unit 210 may transform the reconstructed feature map latent representation ŷ into the reconstructed intermediate latent representation u^{l}. In addition, the feature map transform unit 210 may adjust the resolution of the reconstructed feature map latent representation according to the resolution of the feature map of the current layer.

When the number of layers to be reconstructed is plural, the number of feature map transform units may be used as many as the number of layers to be reconstructed. That is, each feature map transform unit may reconstruct the intermediate latent representation of the corresponding layer from the reconstructed latent representation.

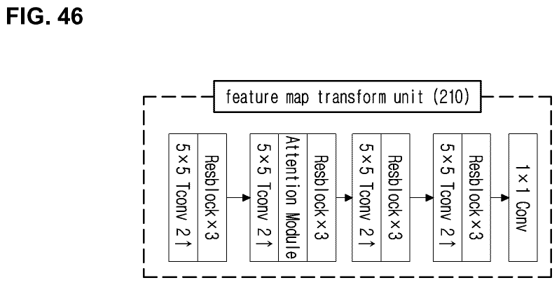

FIG. 46 illustrates a configuration of the feature map transform unit.

As in the example illustrated in FIG. 46, the feature map transform unit (210) may have a structure in which convolution layers and attention blocks are stacked.

Alternatively, the feature map transform unit may be configured by combining conventional neural network-based encoding blocks for image processing.

As illustrated in FIG. 46, the resolution of the reconstructed feature map latent representation may be increased through the 5×5 Tconv2↑ layer.

### [D2] Step of Adapting/Fusing Latent Representation

The latent representation adaptation/fusion step is to adapt the latent representation to the feature map of each layer in order to reconstruct the feature map of each layer.

Meanwhile, either the step of fusing latent representations [D2-1] or the adapting latent representation [D2-2] may be performed selectively. Each of [D2-1] and [D2-2] steps may be performed by the latent representation fusion unit 220 and the latent representation adaptation unit 220, respectively.

### [D2-1] Step of Fusing Latent Representations

The present step may be performed by the latent representation fusion unit 221. The latent representation fusion unit 221 may fuse the reconstructed intermediate latent representation of the current layer and the fused latent representation of the previous layer to generate one latent representation (i.e., fused latent representation).

Meanwhile, for the first layer (i.e., l=1), the fused latent representation of the previous layer does not exist. Accordingly, for the first layer, the step of fusing latent representations may be skipped.

Or, for the first layer, each element of the fused latent expression of the previous layer may be set to a specific constant value (e.g., 0).

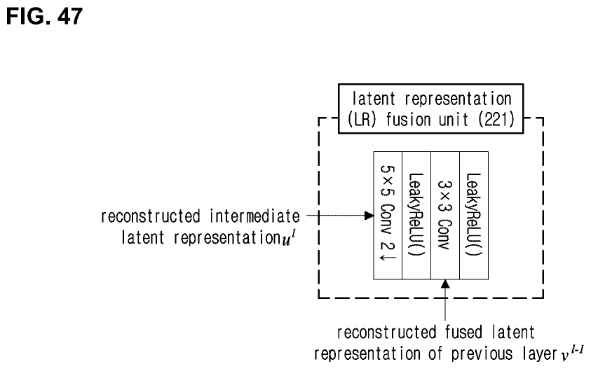

FIG. 47 illustrates a configuration of the latent representation fusion unit.

As in the example illustrated in FIG. 47, the latent representation fusion unit may have a structure in which convolutional layers and attention blocks are stacked.

Alternatively, the latent representation fusion unit may be configured by combining conventional neural network-based encoding blocks for image processing.

### [D2-2] Step of Adapting Latent Representation

The present step may be performed by the latent representation adaptation unit 220.

The latent representation adaptation unit 220 may receive the reconstructed intermediate latent representation of the current layer as input and generate the adaptive intermediate latent representation of the current layer.

Meanwhile, the latent representation adaptation unit may not be used for the last layer (i.e., l=L).

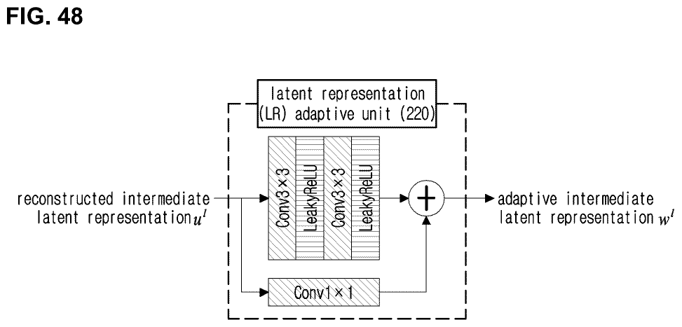

FIG. 48 illustrates a configuration of the latent representation adaptation unit.

As shown in the example illustrated in FIG. 48, the latent representation adaptation unit may have a structure in which convolutional layers are stacked.

Alternatively, the latent representation adaptation unit may be configured by combining conventional neural network-based encoding blocks for image processing.

### [D1] Step of Channel Separation

The channel separation unit 230 performs channel separation (or feature map separation) of the reconstructed adaptive/fused latent representation v^{l} of the current layer, which has NC(v^{l}) channels.

At this time, the channel separation may be performed based on a 1×1 sized convolution kernel, or may be performed through a channel unpadding method.

Since feature maps having different numbers of channels are encoded, it is necessary to separate the reconstructed adaptive/fused latent representation into feature maps having different numbers of channels. That is, the channel separation unit 230 may separate the adaptive/fused latent representation into multiple feature maps through channel separation. Accordingly, the reconstructed feature maps may have the same number of channels as the original feature maps.

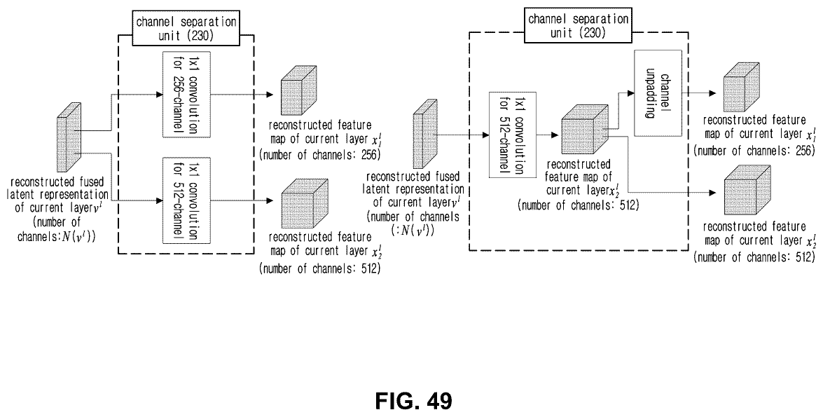

FIG. 49 shows an example in which channel separation is performed based on convolution kernels.

The first reconstructed feature map should have 256 channels, and the second reconstructed feature map should have 512 channels. Accordingly, a 1×1 sized convolution kernel to separate the adaptive/fused latent representation into the feature map of 256 channels, and a 1×1 sized convolution kernel to separate adaptive/fused latent representation into the feature map of 512 channels may be used. In this way, when the number of output channels of the feature maps to be reconstructed is different, a plurality of 1×1 convolution kernels each of which matches to the number of output channels of each feature map is required. In other words, as many 1×1 convolution kernels as the number of types of output channels are required.

FIG. 49 shows an example of channel separation performed by channel unpadding.

In cases where feature maps of 256 channels and feature maps of 512 channels need to be reconstructed, 512 channels may be used as they are or 256 channels may be unpaded.

In addition, by utilizing a 1×1 sized convolution kernel and unpadding, the number of required 1×1 convolution kernels may be reduced.

Specifically, one or more fixed-sized 1×1 convolution kernels may be predefined according to one or more the reference number of channels to be output. Afterwards, a convolution kernel having a larger number of output channels than the number of channels of the feature map to be reconstructed may be selected, and then a feature map having a desired number of channels may be obtained by unpadding unnecessary channels. Meanwhile, if there are multiple convolution kernels having a larger number of output channels than the number of channels of the feature map to be reconstructed, a convolution kernel having a smallest number of output channels among the multiple convolution kernels may be selected. For example, if the reference number of output channels is 100, 200, and 300, three 1×1 convolution kernels may be prepared in advance according to these three cases.

If the feature map to be reconstructed has 155 channels, a 1×1 convolution kernel that outputs 200 channels may be selected. If 200 channels are output through the 1×1 convolution kernel, a feature map with 155 channels may be reconstructed by unpadding 45 channels.

According to these embodiments, channel numbers from 1 to 300 can be covered by only three convolution kernels.

A name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

What is claimed is:

1. A method of decoding a features map, the method comprising:
reconstructing an intermediate latent representation of a current layer from a reconstructed latent representation by obtaining decoding an image;
generating an adaptive latent representation or a fused latent representation based on the intermediate latent representation of the current layer; and
reconstructing a feature map of the current layer by performing channel separation to the adaptive latent representation or the fused latent representation.

2. The method of claim 1, wherein the channel separation represents separating the adaptive latent representation or the fused latent representation into a plurality of channel groups according to a number of channels of the feature map.

3. The method of claim 1, wherein the adaptive latent representation is obtained by adapting the intermediate latent representation of the current layer to a feature map of a reconstruction target layer, and
wherein the fused latent representation is obtained by fusing the intermediate latent representation of the current layer and an intermediate latent representation of a previous layer.

4. The method of claim 3, wherein in response to the current layer being a first layer, the intermediate latent representation of the previous layer is replaced by an intermediate latent representation that values therein are padded by a pre-defined value.

5. The method of claim 4, wherein the pre-defined value is 0.

6. The method of claim 3, wherein in response to the current layer being a first layer, the intermediate latent representation of the previous layer is not input.

7. The method of claim 2, wherein the channel separation is performed by inputting the adaptive latent representation or the fused latent representation to a 1×1 convolution kernel.

8. The method of claim 2, wherein the channel separation is performed by unpadding the adaptive latent representation or the fused latent representation.

9. The method of claim 2, wherein the channel separation is performed by unpadding at least one of a plurality of channels obtained by inputting the adaptive latent representation or the fused latent representation to a 1×1 convolution kernel.

10. A method of encoding a feature map, the method comprising:
adjusting a number of channels of a feature map of a current layer;
separating the feature map with the adjusted number of channels into a plurality of channel groups;
transforming each of the plurality of channel groups into an intermediate latent representation; and
obtaining a feature map latent representation of the current layer by merging intermediate latent representations.

11. The method of claim 10, wherein a number of the channel groups does not exceed a pre-defined value.

12. The method of claim 10, wherein the feature map is separated to the plurality of channel group so as that a number of channels of each of the channel group to be the same as a number of channels input for transforming into an intermediate latent representation.

13. The method of claim 10, wherein a number of channels of the feature map of the current layer is adjusted to a reference number.

14. The method of claim 13, wherein in response to the number of channels of the feature map of the current layer is the same as the reference number, adjusting the number of channels for the feature map of the current layer is skipped.

15. The method of claim 13, wherein the reference number is set to be the same as a number of channels of a layer that has a largest number of channels among a plurality of layers.

16. The method of claim 10, wherein the intermediate latent representation is obtained based on a corresponding channel group and a feature map latent representation of a previous layer.

17. The method of claim 16, wherein in response to the current layer being a first layer, the feature map latent representation of the previous layer is replaced by a feature map latent representation that values therein are padded by a pre-defined value.

18. The method of claim 17, wherein the pre-defined value is 0.

19. The method of claim 16, wherein the feature map latent representation of the current layer is obtained by connecting the intermediate latent representations in a channel direction and then inputting connected intermediate latent representations into a 1×1 convolution kernel.

20. A non-transitory computer readable medium storing instructions for performing a method of encoding a feature map, the method comprising:
adjusting a number of channels of a feature map of a current layer,
separating the feature map with the adjusted number of channels into a plurality of channel groups;
transforming each of the plurality of channel groups into an intermediate latent representation; and
obtaining a feature map latent representation of the current layer by merging intermediate latent representations.
